(19) United States
(12) Patent Application Publication
(10) Pub. No.: US 2022/0329303 A1
(43) Pub. Date: Oct. 13, 2022

(54) METHOD AND APPARATUS FOR CONFIGURING CSI REPORTING GRANULARITY

(71) Applicant: Samsung Electronics Co., Ltd., Suwon-si (KR)

(72) Inventors: Md. Saifur Rahman, Plano, TX (US); Eko Onggosanusi, Coppell, TX (US)

(21) Appl. No.: 17/701,442

(22) Filed: Mar. 22, 2022

Related U.S. Application Data
(60) Provisional application No. 63/165,956, filed on Mar. 25, 2021.

(51) Int. Cl. H04B 7/06; H04B 17/309; H04L 5/00

(52) U.S. Cl. CPC H04B 7/0626; H04B 17/309; H04L 5/0048

(57) ABSTRACT

A method for operating a user equipment (UE) comprises receiving a configuration about a channel state information (CSI) report, the configuration including information about a CSI reference signal (CSI-RS) burst comprising B>1 time instances of CSI-RS transmission, and a time domain (TD) unit comprising N_{ST} consecutive time instances; measuring the CSI-RS burst; determining, based on the measurement of the CSI-RS burst and the TD unit, TD or Doppler domain (DD) components of a downlink (DL) channel; and transmitting the CSI report including an indication about the TD or DD components of the DL channel.

### CROSS-REFERENCE TO RELATED APPLICATIONS AND CLAIM OF PRIORITY

The present application claims priority to U.S. Provisional Patent Application No. 63/165,956, filed on Mar. 25, 2021. The content of the above-identified patent document is incorporated herein by reference.

### TECHNICAL FIELD

The present disclosure relates generally to wireless communication systems and more specifically to configuring CSI reporting granularity.

### BACKGROUND

Understanding and correctly estimating the channel between a user equipment (UE) and a base station (BS) (e.g., gNode B (gNB)) is important for efficient and effective wireless communication. In order to correctly estimate the DL channel conditions, the gNB may transmit a reference signal, e.g., CSI-RS, to the UE for DL channel measurement, and the UE may report (e.g., feedback) information about channel measurement, e.g., CSI, to the gNB. With this DL channel measurement, the gNB is able to select appropriate communication parameters to efficiently and effectively perform wireless data communication with the UE.

### SUMMARY

Embodiments of the present disclosure provide methods and apparatuses to enable configuring CSI reporting granularity.

In one embodiment, a UE in a wireless communication system is provided. The UE includes a transceiver configured to: receive a configuration about a channel state information (CSI) report, the configuration including information about a CSI reference signal (CSI-RS) burst comprising B>1 time instances of CSI-RS transmission, and a time domain (TD) unit comprising N_{ST} consecutive time instances. The UE further includes a processor operably coupled to the transceiver. The processor is configured to: measure the CSI-RS burst; and determine, based on the measurement of the CSI-RS burst and the TD unit, TD or Doppler domain (DD) components of a downlink (DL) channel. The transmitter is further configured to transmit the CSI report including an indication about the TD or DD components of the DL channel.

In another embodiment, a BS in a wireless communication system is provided. The BS includes a processor configured to: generate a configuration about a CSI report, the configuration including information about a CSI-RS burst comprising B>1 time instances of CSI-RS transmission, and a TD unit comprising N_{ST} consecutive time instances. The BS further includes a transceiver operably coupled to the processor. The transceiver is configured to: transmit the configuration; transmit the CSI-RS burst; and receive the CSI report including an indication about TD or DD components of a DL channel, wherein the TD or DD components of the DL channel are based on the CSI-RS burst and the TD unit.

In yet another embodiment, a method for operating a UE is provided. The method comprises: receiving a configuration about a CSI report, the configuration including information about a CSI-RS burst comprising B>1 time instances of CSI-RS transmission, and a TD unit comprising N_{ST} consecutive time instances; measuring the CSI-RS burst; determining, based on the measurement of the CSI-RS burst and the TD unit, TD or DD components of a DL channel; and transmitting the CSI report including an indication about the TD or DD components of the DL channel.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4A illustrates a high-level diagram of an orthogonal frequency division multiple access transmit path according to embodiments of the present disclosure;

FIG. 4B illustrates a high-level diagram of an orthogonal frequency division multiple access receive path according to embodiments of the present disclosure;

FIG. 5 illustrates a transmitter block diagram for a PDSCH in a subframe according to embodiments of the present disclosure;

FIG. 6 illustrates a receiver block diagram for a PDSCH in a subframe according to embodiments of the present disclosure;

FIG. 7 illustrates a transmitter block diagram for a PUSCH in a subframe according to embodiments of the present disclosure;

FIG. 8 illustrates a receiver block diagram for a PUSCH in a subframe according to embodiments of the present disclosure;

FIG. 9 illustrates an example antenna blocks or arrays forming beams according to embodiments of the present disclosure;

FIG. 10 illustrates channel measurements with and without Doppler components according to embodiments of the present disclosure;

FIG. 11 illustrates an antenna port layout according to embodiments of the present disclosure;

FIG. 12 illustrates a 3D grid of oversampled DFT beams according to embodiments of the present disclosure;

FIG. 13 illustrates an example of a UE configured to receive a burst of NZP CSI-RS resources according to embodiments of the present disclosure;

FIG. 14 illustrates an example of a UE configured to determine a value of N₄ based on the value B in a CSI-RS burst according to embodiments of the present disclosure;

FIG. 15 illustrates an example of a UE configured to determine a value of N₄ when N_{ST} does not divide B according to embodiments of the present disclosure;

FIG. 16 illustrates an example of a UE configured to determine a value of N₄ when N_{ST} does not divide B according to embodiments of the present disclosure;

FIG. 17 illustrates an example of a UE configured to determine a value of N₄ when N_{ST} does not divide B according to embodiments of the present disclosure;

FIG. 18 illustrates an example of a UE configured to determine a value of N₄ based on the ST unit according to embodiments of the present disclosure;

FIG. 19 illustrates an example of a UE configured to determine a value of N₄ based on the value B across J>1 CSI-RS bursts according to embodiments of the present disclosure;

FIG. 20 illustrates an example of a UE configured to determine a value of N₄ based on the value B across an aggregated CSI-RS burst according to embodiments of the present disclosure;

FIG. 21 illustrates an example of a UE configured to determine a value of N₄ based on the ST units formed across J CSI-RS bursts according to embodiments of the present disclosure;

FIG. 22 illustrates an example of a UE configured to determine a value of N₄ with J≥1 CSI-RS bursts that occupy a frequency band and a time span according to embodiments of the present disclosure;

FIG. 23 illustrates a flow chart of a method for operating a UE according to embodiments of the present disclosure; and

FIG. 24 illustrates a flow chart of a method for operating a BS according to embodiments of the present disclosure.

### DETAILED DESCRIPTION

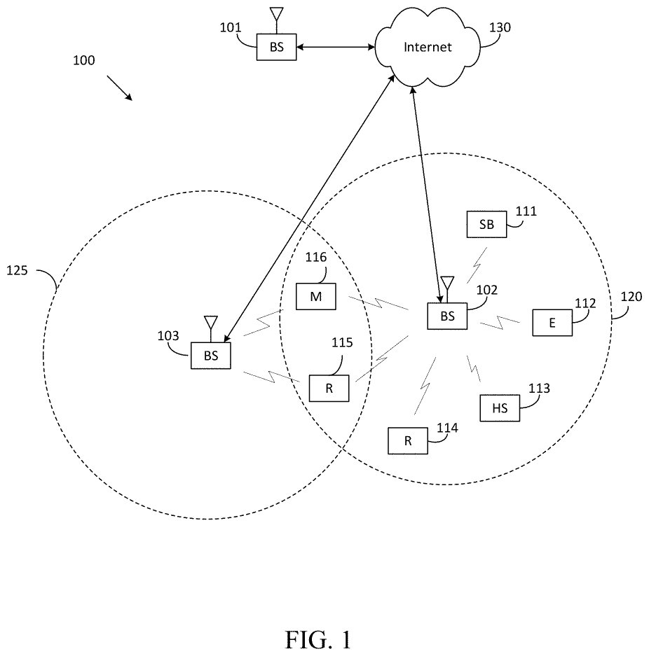

FIG. 1 through FIG. 24, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: 3GPP TS 36.211 v17.0.0, “E-UTRA, Physical channels and modulation” (herein “REF 1”); 3GPP TS 36.212 v17.0.0, “E-UTRA, Multiplexing and Channel coding” (herein “REF 2”); 3GPP TS 36.213 v17.0.0, “E-UTRA, Physical Layer Procedures” (herein “REF 3”); 3GPP TS 36.321 v16.6.0, “E-UTRA, Medium Access Control (MAC) protocol specification” (herein “REF 4”); 3GPP TS 36.331 v16.7.0, “E-UTRA, Radio Resource Control (RRC) protocol specification” (herein “REF 5”); 3GPP TR 22.891 v1.2.0 (herein “REF 6”); 3GPP TS 38.212 v17.0.0, “E-UTRA, NR, Multiplexing and channel coding” (herein “REF 7”); 3GPP TS 38.214 v17.0.0, “E-UTRA, NR, Physical layer procedures for data” (herein “REF 8”); RP-192978, “Measurement results on Doppler spectrum for various UE mobility environments and related CSI enhancements,” Fraunhofer IIS, Fraunhofer HHI, Deutsche Telekom (herein “REF 9”); and 3GPP TS 38.211 v17.0.0, “E-UTRA, NR, Physical channels and modulation (herein “REF 10”).

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

In the following, for brevity, both FDD and TDD are considered as the duplex method for both DL and UL signaling.

Although exemplary descriptions and embodiments to follow assume orthogonal frequency division multiplexing (OFDM) or orthogonal frequency division multiple access (OFDMA), the present disclosure can be extended to other OFDM-based transmission waveforms or multiple access schemes such as filtered OFDM (F-OFDM).

To meet the demand for wireless data traffic having increased since deployment of 4G communication systems, efforts have been made to develop an improved 5G or pre-5G communication system. Therefore, the 5G or pre-5G communication system is also called a “beyond 4G network” or a “post LTE system.”

The 5G communication system is considered to be implemented in higher frequency (mmWave) bands, e.g., 60 GHz bands, so as to accomplish higher data rates or in lower frequency bands, such as below 6 GHz, to enable robust coverage and mobility support. To decrease propagation loss of the radio waves and increase the transmission coverage, the beamforming, massive multiple-input multiple-output (MIMO), full dimensional MIMO (FD-MIMO), array antenna, an analog beam forming, large scale antenna techniques and the like are discussed in 5G communication systems.

In addition, in 5G communication systems, development for system network improvement is under way based on advanced small cells, cloud radio access networks (RANs), ultra-dense networks, device-to-device (D2D) communication, wireless backhaul communication, moving network, cooperative communication, coordinated multi-points (CoMP) transmission and reception, interference mitigation and cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-4B below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system. The present disclosure covers several components which can be used in conjunction or in combination with one another, or can operate as standalone schemes.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101, a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, LTE, LTE-A, WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G base station (gNB), a macrocell, a femtocell, a WiFi access point (AP), or other wirelessly enabled devices. Base stations may provide wireless access in accordance with one or more wireless communication protocols, e.g., 5G 3GPP new radio interface/access (NR), long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for receiving a configuration about a channel state information (CSI) report, the configuration including information about a CSI reference signal (CSI-RS) burst comprising B>1 time instances of CSI-RS transmission, and a time domain (TD) unit comprising N_{ST} consecutive time instances; measuring the CSI-RS burst; determining, based on the measurement of the CSI-RS burst and the TD unit, TD or Doppler domain (DD) components of a downlink (DL) channel; and transmitting the CSI report including an indication about the TD or DD components of the DL channel. One or more of the gNBs 101-103 includes circuitry, programing, or a combination thereof, for generating a configuration about a channel state information (CSI) report, the configuration including information about a CSI reference signal (CSI-RS) burst comprising B>1 time instances of CSI-RS transmission, and a time domain (TD) unit comprising N_{ST} consecutive time instances; transmitting the configuration; transmitting the CSI-RS burst; and receiving the CSI report including an indication about TD or Doppler domain (DD) components of a downlink (DL) channel, wherein the TD or DD components of the DL channel are based on the CSI-RS burst and the TD unit.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

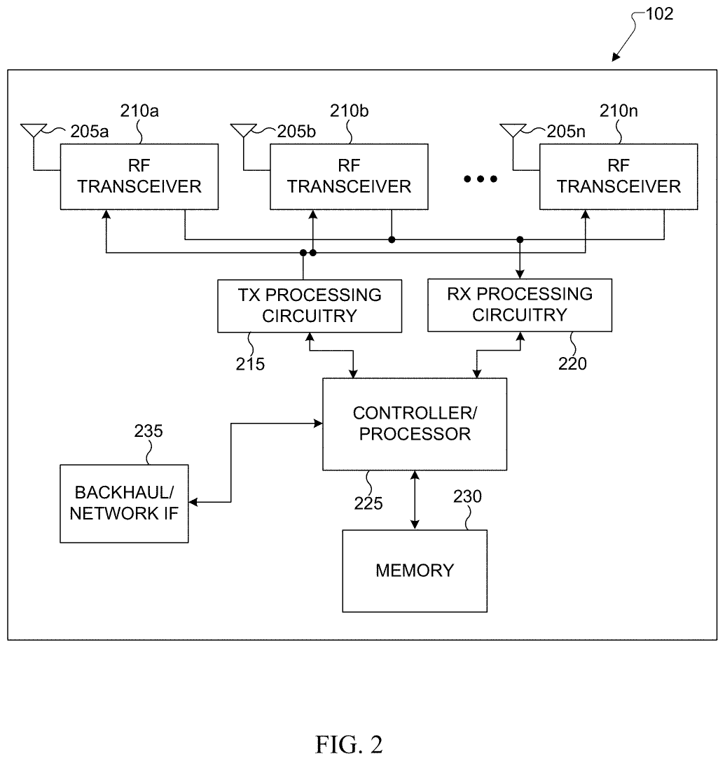

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the RF transceivers 210a-210n, the RX processing circuitry 220, and the TX processing circuitry 215 in accordance with well-known principles. The controller/processor 225 could support additional functions as well, such as more advanced wireless communication functions.

For instance, the controller/processor 225 could support beam forming or directional routing operations in which outgoing signals from multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support routing functions to route data between different network addresses. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

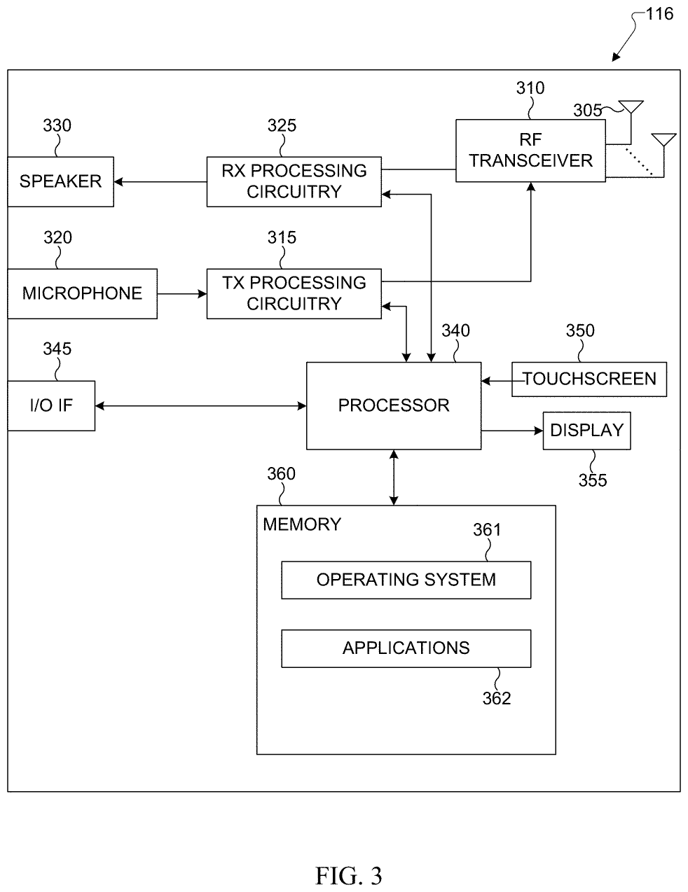

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for receiving a configuration about a channel state information (CSI) report, the configuration including information about a CSI reference signal (CSI-RS) burst comprising B>1 time instances of CSI-RS transmission, and a time domain (TD) unit comprising N_{ST} consecutive time instances; measuring the CSI-RS burst; determining, based on the measurement of the CSI-RS burst and the TD unit, TD or Doppler domain (DD) components of a downlink (DL) channel; and transmitting the CSI report including an indication about the TD or DD components of the DL channel. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

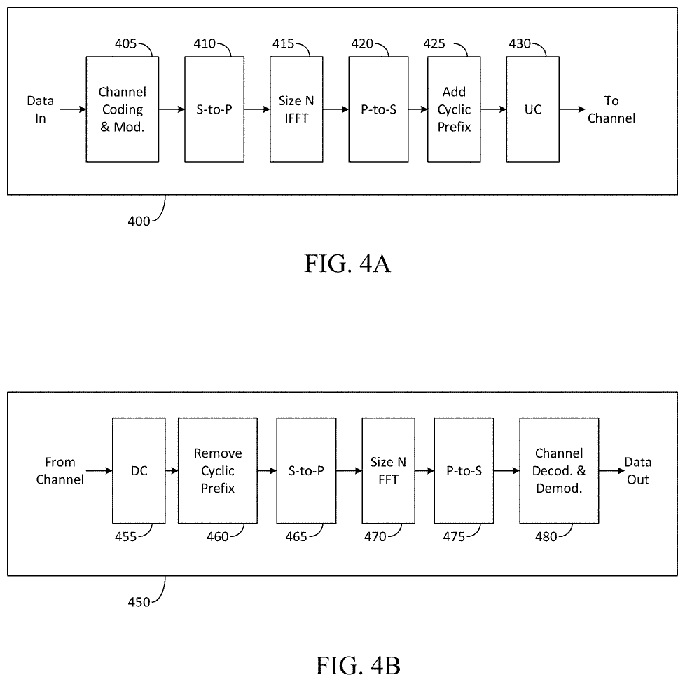

FIG. 4A is a high-level diagram of transmit path circuitry. For example, the transmit path circuitry may be used for an orthogonal frequency division multiple access (OFDMA) communication. FIG. 4B is a high-level diagram of receive path circuitry. For example, the receive path circuitry may be used for an orthogonal frequency division multiple access (OFDMA) communication. In FIGS. 4A and 4B, for downlink communication, the transmit path circuitry may be implemented in a base station (gNB) 102 or a relay station, and the receive path circuitry may be implemented in a user equipment (e.g., user equipment 116 of FIG. 1). In other examples, for uplink communication, the receive path circuitry 450 may be implemented in a base station (e.g., gNB 102 of FIG. 1) or a relay station, and the transmit path circuitry may be implemented in a user equipment (e.g., user equipment 116 of FIG. 1).

Transmit path circuitry comprises channel coding and modulation block 405, serial-to-parallel (S-to-P) block 410, Size N Inverse Fast Fourier Transform (IFFT) block 415, parallel-to-serial (P-to-S) block 420, add cyclic prefix block 425, and up-converter (UC) 430. Receive path circuitry 450 comprises down-converter (DC) 455, remove cyclic prefix block 460, serial-to-parallel (S-to-P) block 465, Size N Fast Fourier Transform (FFT) block 470, parallel-to-serial (P-to-S) block 475, and channel decoding and demodulation block 480.

At least some of the components in FIGS. 4A 400 and 4B 450 may be implemented in software, while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and may not be construed to limit the scope of the disclosure. It may be appreciated that in an alternate embodiment of the present disclosure, the Fast Fourier Transform functions and the Inverse Fast Fourier Transform functions may easily be replaced by discrete Fourier transform (DFT) functions and inverse discrete Fourier transform (IDFT) functions, respectively. It may be appreciated that for DFT and IDFT functions, the value of the N variable may be any integer number (i.e., 1, 4, 3, 4, etc.), while for FFT and IFFT functions, the value of the N variable may be any integer number that is a power of two (i.e., 1, 2, 4, 8, 16, etc.).

In transmit path circuitry 400, channel coding and modulation block 405 receives a set of information bits, applies coding (e.g., LDPC coding) and modulates (e.g., quadrature phase shift keying (QPSK) or quadrature amplitude modulation (QAM)) the input bits to produce a sequence of frequency-domain modulation symbols. Serial-to-parallel block 410 converts (i.e., de-multiplexes) the serial modulated symbols to parallel data to produce N parallel symbol streams where N is the IFFT/FFT size used in BS 102 and UE 116. Size N IFFT block 415 then performs an IFFT operation on the N parallel symbol streams to produce time-domain output signals. Parallel-to-serial block 420 converts (i.e., multiplexes) the parallel time-domain output symbols from Size N IFFT block 415 to produce a serial time-domain signal. Add cyclic prefix block 425 then inserts a cyclic prefix to the time-domain signal. Finally, up-converter 430 modulates (i.e., up-converts) the output of add cyclic prefix block 425 to RF frequency for transmission via a wireless channel. The signal may also be filtered at baseband before conversion to RF frequency.

The transmitted RF signal arrives at the UE 116 after passing through the wireless channel, and reverse operations to those at gNB 102 are performed. Down-converter 455 down-converts the received signal to baseband frequency and removes cyclic prefix block 460, and removes the cyclic prefix to produce the serial time-domain baseband signal. Serial-to-parallel block 465 converts the time-domain baseband signal to parallel time-domain signals. Size N FFT block 470 then performs an FFT algorithm to produce N parallel frequency-domain signals. Parallel-to-serial block 475 converts the parallel frequency-domain signals to a sequence of modulated data symbols. Channel decoding and demodulation block 480 demodulates and then decodes the modulated symbols to recover the original input data stream.

Each of gNBs 101-103 may implement a transmit path that is analogous to transmitting in the downlink to user equipment 111-116 and may implement a receive path that is analogous to receiving in the uplink from user equipment 111-116. Similarly, each one of user equipment 111-116 may implement a transmit path corresponding to the architecture for transmitting in the uplink to gNBs 101-103 and may implement a receive path corresponding to the architecture for receiving in the downlink from gNBs 101-103.

5G communication system use cases have been identified and described. Those use cases can be roughly categorized into three different groups. In one example, enhanced mobile broadband (eMBB) is determined to do with high bits/sec requirement, with less stringent latency and reliability requirements. In another example, ultra reliable and low latency (URLL) is determined with less stringent bits/sec requirement. In yet another example, massive machine type communication (mMTC) is determined that a number of devices can be as many as 100,000 to 1 million per km2, but the reliability/throughput/latency requirement could be less stringent. This scenario may also involve power efficiency requirement as well, in that the battery consumption may be minimized as possible.

A communication system includes a downlink (DL) that conveys signals from transmission points such as base stations (BSs) or NodeBs to user equipments (UEs) and an Uplink (UL) that conveys signals from UEs to reception points such as NodeBs. A UE, also commonly referred to as a terminal or a mobile station, may be fixed or mobile and may be a cellular phone, a personal computer device, or an automated device. An eNodeB, which is generally a fixed station, may also be referred to as an access point or other equivalent terminology. For LTE systems, a NodeB is often referred as an eNodeB.

In a communication system, such as LTE system, DL signals can include data signals conveying information content, control signals conveying DL control information (DCI), and reference signals (RS) that are also known as pilot signals. An eNodeB transmits data information through a physical DL shared channel (PDSCH). An eNodeB transmits DCI through a physical DL control channel (PDCCH) or an Enhanced PDCCH (EPDCCH).

An eNodeB transmits acknowledgement information in response to data transport block (TB) transmission from a UE in a physical hybrid ARQ indicator channel (PHICH). An eNodeB transmits one or more of multiple types of RS including a UE-common RS (CRS), a channel state information RS (CSI-RS), or a demodulation RS (DMRS). A CRS is transmitted over a DL system bandwidth (BW) and can be used by UEs to obtain a channel estimate to demodulate data or control information or to perform measurements. To reduce CRS overhead, an eNodeB may transmit a CSI-RS with a smaller density in the time and/or frequency domain than a CRS. DMRS can be transmitted only in the BW of a respective PDSCH or EPDCCH and a UE can use the DMRS to demodulate data or control information in a PDSCH or an EPDCCH, respectively. A transmission time interval for DL channels is referred to as a subframe and can have, for example, duration of 1 millisecond.

DL signals also include transmission of a logical channel that carries system control information. A BCCH is mapped to either a transport channel referred to as a broadcast channel (BCH) when the DL signals convey a master information block (MIB) or to a DL shared channel (DL-SCH) when the DL signals convey a System Information Block (SIB). Most system information is included in different SIBs that are transmitted using DL-SCH. A presence of system information on a DL-SCH in a subframe can be indicated by a transmission of a corresponding PDCCH conveying a codeword with a cyclic redundancy check (CRC) scrambled with system information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe and a group of physical resource blocks (PRBs). A transmission BW includes frequency resource units referred to as resource blocks (RBs). Each RB includes N_{sc}^{RB} sub-carriers, or resource elements (REs), such as 12 REs. A unit of one RB over one subframe is referred to as a PRB. A UE can be allocated M_{PDSCH} RBs for a total of M_{sc}^{PDSCH}=M_{PDSCH}·N_{sc}^{RB} REs for the PDSCH transmission BW.

UL signals can include data signals conveying data information, control signals conveying UL control information (UCI), and UL RS. UL RS includes DMRS and Sounding RS (SRS). A UE transmits DMRS only in a BW of a respective PUSCH or PUCCH. An eNodeB can use a DMRS to demodulate data signals or UCI signals. A UE transmits SRS to provide an eNodeB with an UL CSI. A UE transmits data information or UCI through a respective physical UL shared channel (PUSCH) or a Physical UL control channel (PUCCH). If a UE needs to transmit data information and UCI in a same UL subframe, the UE may multiplex both in a PUSCH. UCI includes Hybrid Automatic Repeat request acknowledgement (HARQ-ACK) information, indicating correct (ACK) or incorrect (NACK) detection for a data TB in a PDSCH or absence of a PDCCH detection (DTX), scheduling request (SR) indicating whether a UE has data in the UE's buffer, rank indicator (RI), and channel state information (CSI) enabling an eNodeB to perform link adaptation for PDSCH transmissions to a UE. HARQ-ACK information is also transmitted by a UE in response to a detection of a PDCCH/EPDCCH indicating a release of semi-persistently scheduled PDSCH.

An UL subframe includes two slots. Each slot includes N_{symb}^{UL} symbols for transmitting data information, UCI, DMRS, or SRS. A frequency resource unit of an UL system BW is a RB. A UE is allocated N_{RB} RBs for a total of N_{RB}·N_{sc}^{RB} REs for a transmission BW. For a PUCCH, N_{RB}=1. A last subframe symbol can be used to multiplex SRS transmissions from one or more UEs. A number of subframe symbols that are available for data/UCI/DMRS transmission is N_{symb}=2·(N_{symb}^{UL}−1)−N_{SRS}, where N_{SRS}=1 if a last subframe symbol is used to transmit SRS and N_{SRS}=0 otherwise.

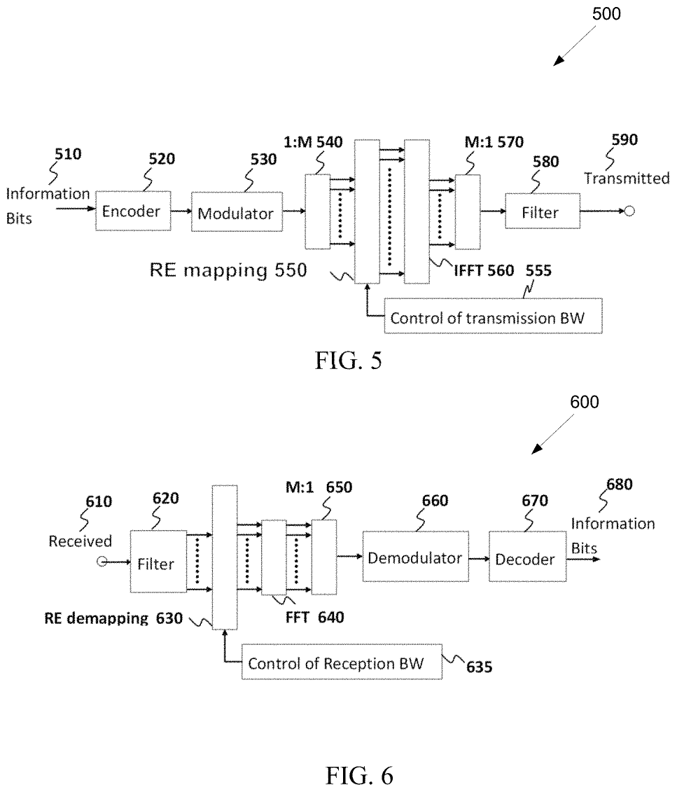

FIG. 5 illustrates a transmitter block diagram 500 for a PDSCH in a subframe according to embodiments of the present disclosure. The embodiment of the transmitter block diagram 500 illustrated in FIG. 5 is for illustration only. One or more of the components illustrated in FIG. 5 can be implemented in specialized circuitry configured to perform the noted functions or one or more of the components can be implemented by one or more processors executing instructions to perform the noted functions. FIG. 5 does not limit the scope of this disclosure to any particular implementation of the transmitter block diagram 500.

As shown in FIG. 5, information bits 510 are encoded by encoder 520, such as a turbo encoder, and modulated by modulator 530, for example using quadrature phase shift keying (QPSK) modulation. A serial to parallel (S/P) converter 540 generates M modulation symbols that are subsequently provided to a mapper 550 to be mapped to REs selected by a transmission BW selection unit 555 for an assigned PDSCH transmission BW, unit 560 applies an Inverse fast Fourier transform (IFFT), the output is then serialized by a parallel to serial (P/S) converter 570 to create a time domain signal, filtering is applied by filter 580, and a signal transmitted 590. Additional functionalities, such as data scrambling, cyclic prefix insertion, time windowing, interleaving, and others are well known in the art and are not shown for brevity.

FIG. 6 illustrates a receiver block diagram 600 for a PDSCH in a subframe according to embodiments of the present disclosure. The embodiment of the diagram 600 illustrated in FIG. 6 is for illustration only. One or more of the components illustrated in FIG. 6 can be implemented in specialized circuitry configured to perform the noted functions or one or more of the components can be implemented by one or more processors executing instructions to perform the noted functions. FIG. 6 does not limit the scope of this disclosure to any particular implementation of the diagram 600.

As shown in FIG. 6, a received signal 610 is filtered by filter 620, REs 630 for an assigned reception BW are selected by BW selector 635, unit 640 applies a fast Fourier transform (FFT), and an output is serialized by a parallel-to-serial converter 650. Subsequently, a demodulator 660 coherently demodulates data symbols by applying a channel estimate obtained from a DMRS or a CRS (not shown), and a decoder 670, such as a turbo decoder, decodes the demodulated data to provide an estimate of the information data bits 680. Additional functionalities such as time-windowing, cyclic prefix removal, de-scrambling, channel estimation, and de-interleaving are not shown for brevity.

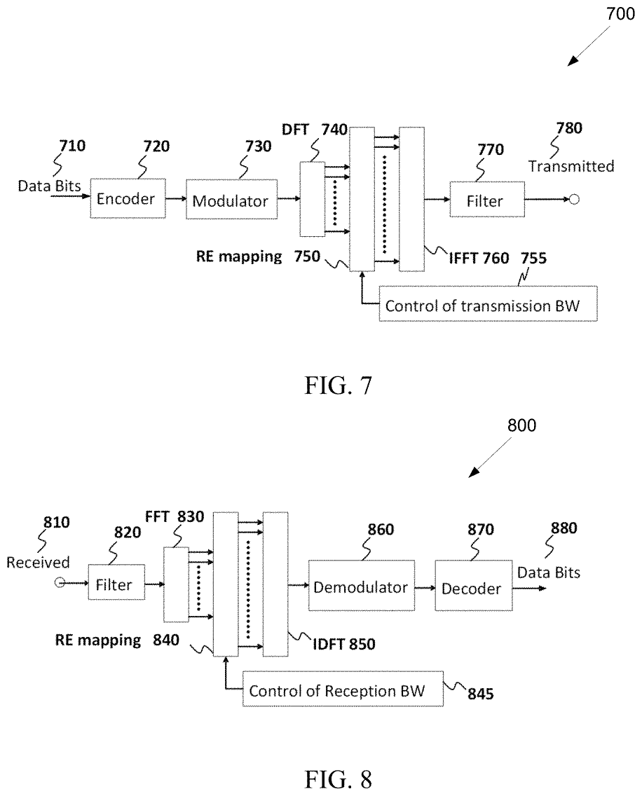

FIG. 7 illustrates a transmitter block diagram 700 for a PUSCH in a subframe according to embodiments of the present disclosure. The embodiment of the block diagram 700 illustrated in FIG. 7 is for illustration only. One or more of the components illustrated in FIG. 5 can be implemented in specialized circuitry configured to perform the noted functions or one or more of the components can be implemented by one or more processors executing instructions to perform the noted functions. FIG. 7 does not limit the scope of this disclosure to any particular implementation of the block diagram 700.

As shown in FIG. 7, information data bits 710 are encoded by encoder 720, such as a turbo encoder, and modulated by modulator 730. A discrete Fourier transform (DFT) unit 740 applies a DFT on the modulated data bits, REs 750 corresponding to an assigned PUSCH transmission BW are selected by transmission BW selection unit 755, unit 760 applies an IFFT and, after a cyclic prefix insertion (not shown), filtering is applied by filter 770 and a signal transmitted 780.

FIG. 8 illustrates a receiver block diagram 800 for a PUSCH in a subframe according to embodiments of the present disclosure. The embodiment of the block diagram 800 illustrated in FIG. 8 is for illustration only. One or more of the components illustrated in FIG. 8 can be implemented in specialized circuitry configured to perform the noted functions or one or more of the components can be implemented by one or more processors executing instructions to perform the noted functions. FIG. 8 does not limit the scope of this disclosure to any particular implementation of the block diagram 800.

As shown in FIG. 8, a received signal 810 is filtered by filter 820. Subsequently, after a cyclic prefix is removed (not shown), unit 830 applies a FFT, REs 840 corresponding to an assigned PUSCH reception BW are selected by a reception BW selector 845, unit 850 applies an inverse DFT (IDFT), a demodulator 860 coherently demodulates data symbols by applying a channel estimate obtained from a DMRS (not shown), a decoder 870, such as a turbo decoder, decodes the demodulated data to provide an estimate of the information data bits 880.

In next generation cellular systems, various use cases are envisioned beyond the capabilities of LTE system. Termed 5G or the fifth generation cellular system, a system capable of operating at sub-6 GHz and above-6 GHz (for example, in mmWave regime) becomes one of the requirements. In 3GPP TR 22.891, 74 5G use cases have been identified and described; those use cases can be roughly categorized into three different groups. A first group is termed “enhanced mobile broadband (eMBB),” targeted to high data rate services with less stringent latency and reliability requirements. A second group is termed “ultra-reliable and low latency (URLL)” targeted for applications with less stringent data rate requirements, but less tolerant to latency. A third group is termed “massive MTC (mMTC)” targeted for large number of low-power device connections such as 1 million per km′ with less stringent the reliability, data rate, and latency requirements.

The 3GPP NR specification supports up to 32 CSI-RS antenna ports which enable a gNB to be equipped with a large number of antenna elements (such as 64 or 128). In this case, a plurality of antenna elements is mapped onto one CSI-RS port. For next generation cellular systems such as 5G, the maximum number of CSI-RS ports can either remain the same or increase.

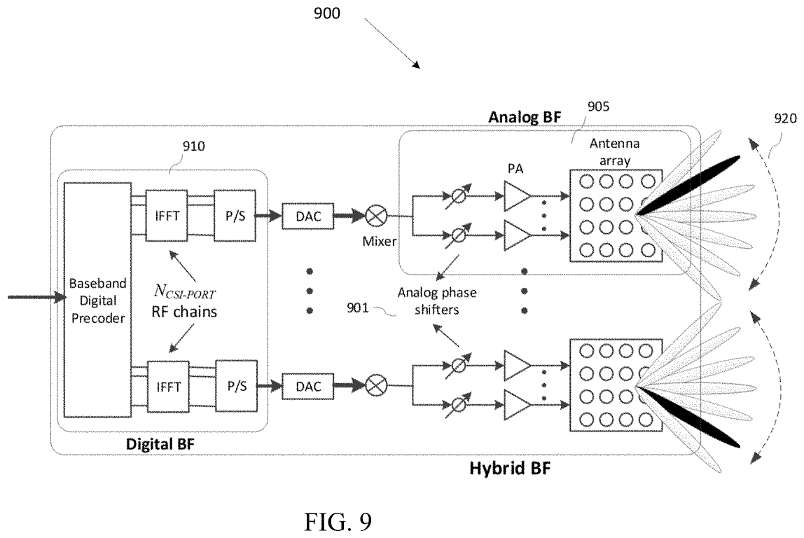

FIG. 9 illustrates an example antenna blocks or arrays 900 according to embodiments of the present disclosure. The embodiment of the antenna blocks or arrays 1100 illustrated in FIG. 9 is for illustration only. FIG. 9 does not limit the scope of this disclosure to any particular implementation of the antenna blocks or arrays 900.

For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 9. In this case, one CSI-RS port is mapped onto a large number of antenna elements which can be controlled by a bank of analog phase shifters 901. One CSI-RS port can then correspond to one sub-array which produces a narrow analog beam through analog beamforming 905. This analog beam can be configured to sweep across a wider range of angles (920) by varying the phase shifter bank across symbols or subframes. The number of sub-arrays (equal to the number of RF chains) is the same as the number of CSI-RS ports N_{CSI-PORT}. A digital beamforming unit 910 performs a linear combination across N_{CSI-PORT} analog beams to further increase precoding gain. While analog beams are wideband (hence not frequency-selective), digital precoding can be varied across frequency sub-bands or resource blocks.

To enable digital precoding, efficient design of CSI-RS is a crucial factor. For this reason, three types of CSI reporting mechanisms corresponding to three types of CSI-RS measurement behavior are supported, for example, “CLASS A” CSI reporting which corresponds to non-precoded CSI-RS, “CLASS B” reporting with K=1 CSI-RS resource which corresponds to UE-specific beamformed CSI-RS, and “CLASS B” reporting with K>1 CSI-RS resources which corresponds to cell-specific beamformed CSI-RS.

For non-precoded (NP) CSI-RS, a cell-specific one-to-one mapping between CSI-RS port and TXRU is utilized. Different CSI-RS ports have the same wide beam width and direction and hence generally cell wide coverage. For beamformed CSI-RS, beamforming operation, either cell-specific or UE-specific, is applied on a non-zero-power (NZP) CSI-RS resource (e.g., comprising multiple ports). At least at a given time/frequency, CSI-RS ports have narrow beam widths and hence not cell wide coverage, and at least from the gNB perspective. At least some CSI-RS port-resource combinations have different beam directions.

In scenarios where DL long-term channel statistics can be measured through UL signals at a serving eNodeB, UE-specific BF CSI-RS can be readily used. This is typically feasible when UL-DL duplex distance is sufficiently small. When this condition does not hold, however, some UE feedback is necessary for the eNodeB to obtain an estimate of DL long-term channel statistics (or any of representation thereof). To facilitate such a procedure, a first BF CSI-RS transmitted with periodicity T1 (ms) and a second NP CSI-RS transmitted with periodicity T2 (ms), where T1≤T2. This approach is termed hybrid CSI-RS. The implementation of hybrid CSI-RS is largely dependent on the definition of CSI process and NZP CSI-RS resource.

In the 3GPP LTE specification, MIMO has been identified as an essential feature in order to achieve high system throughput requirements and it will continue to be the same in NR. One of the key components of a MIMO transmission scheme is the accurate CSI acquisition at the eNB (or TRP). For MU-MIMO, in particular, the availability of accurate CSI is necessary in order to guarantee high MU performance. For TDD systems, the CSI can be acquired using the SRS transmission relying on the channel reciprocity. For FDD systems, on the other hand, the CSI can be acquired using the CSI-RS transmission from the eNB, and CSI acquisition and feedback from the UE. In legacy FDD systems, the CSI feedback framework is ‘implicit’ in the form of CQI/PMI/RI derived from a codebook assuming SU transmission from the eNB. Because of the inherent SU assumption while deriving CSI, this implicit CSI feedback is inadequate for MU transmission. Since future (e.g., NR) systems are likely to be more MU-centric, this SU-MU CSI mismatch will be a bottleneck in achieving high MU performance gains. Another issue with implicit feedback is the scalability with larger number of antenna ports at the eNB. For large number of antenna ports, the codebook design for implicit feedback is quite complicated, and the designed codebook is not guaranteed to bring justifiable performance benefits in practical deployment scenarios (for example, only a small percentage gain can be shown at the most).

In 5G or NR systems, the above-mentioned CSI reporting paradigm from LTE is also supported and referred to as Type I CSI reporting. In addition to Type I, a high-resolution CSI reporting, referred to as Type II CSI reporting, is also supported to provide more accurate CSI information to gNB for use cases such as high-order MU-MIMO. The overhead of Type II CSI reporting can be an issue in practical UE implementations. One approach to reduce Type II CSI overhead is based on frequency domain (FD) compression. In Rel. 16 NR, DFT-based FD compression of the Type II CSI has been supported (referred to as Rel. 16 enhanced Type II codebook in REF8). Some of the key components for this feature includes (a) spatial domain (SD) basis W₁, (b) FD basis W_{f}, and (c) coefficients \tilde{W}₂ that linearly combine SD and FD basis. In a non-reciprocal FDD system, a complete CSI (comprising all components) needs to be reported by the UE. However, when reciprocity or partial reciprocity does exist between UL and DL, then some of the CSI components can be obtained based on the UL channel estimated using SRS transmission from the UE. In Rel. 16 NR, the DFT-based FD compression is extended to this partial reciprocity case (referred to as Rel. 16 enhanced Type II port selection codebook in REF8), wherein the DFT-based SD basis in W₁ is replaced with SD CSI-RS port selection, i.e., L out of P_{CSI-RS}/2 CSI-RS ports are selected (the selection is common for the two antenna polarizations or two halves of the CSI-RS ports). The CSI-RS ports in this case are beamformed in SD (assuming UL-DL channel reciprocity in angular domain), and the beamforming information can be obtained at the gNB based on UL channel estimated using SRS measurements.

It has been known in the literature that UL-DL channel reciprocity exists in both angular and delay domains if the UL-DL duplexing distance is small. Since delay in time domain transforms (or closely related to) basis vectors in frequency domain (FD), the Rel. 16 enhanced Type II port selection can be further extended to both angular and delay domains (or SD and FD). In particular, the DFT-based SD basis in W₁ and/or DFT-based FD basis in W_{f} can be replaced with SD and FD port selection, i.e., L CSI-RS ports are selected in SD and/or M ports are selected in FD. The CSI-RS ports in this case are beamformed in SD (assuming UL-DL channel reciprocity in angular domain) and/or FD (assuming UL-DL channel reciprocity in delay/frequency domain), and the corresponding SD and/or FD beamforming information can be obtained at the gNB based on UL channel estimated using SRS measurements. In Rel. 17 NR, such a codebook will be supported.

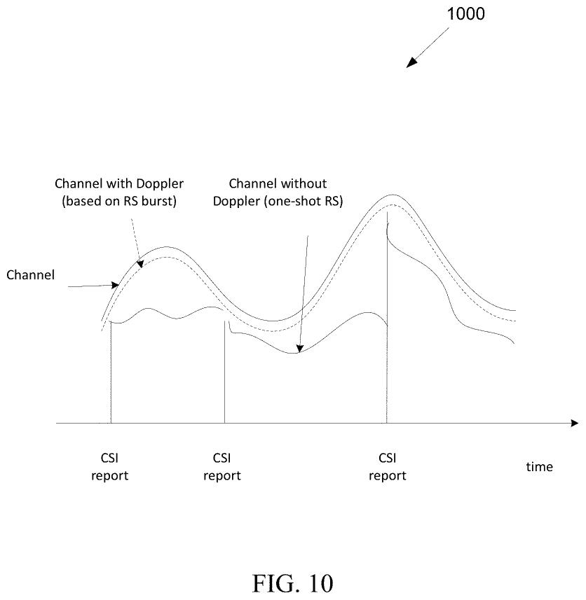

FIG. 10 illustrates channel measurement with and without Doppler components 1000 according to embodiments of the present disclosure. The embodiment of the channel measurement with and without Doppler components 1000 illustrated in FIG. 10 is for illustration only. FIG. 10 does not limit the scope of this disclosure to any particular implementation of the channel measurement with and without Doppler components 1000.

Now, when the UE speed is in a moderate or high speed regime, the performance of the Rel. 15/16/17 codebooks starts to deteriorate quickly due to fast channel variations (which in turn is due to UE mobility that contributes to the Doppler component of the channel), and a one-shot nature of CSI-RS measurement and CSI reporting in Rel. 15/16/17. This limits the usefulness of Rel. 15/16/17 codebooks to low mobility or static UEs only. For moderate or high mobility scenarios, an enhancement in CSI-RS measurement and CSI reporting is needed, which is based on the Doppler components of the channel. As described in [REFS], the Doppler components of the channel remain almost constant over a large time duration, referred to as channel stationarity time, which is significantly larger than the channel coherence time. Note that the current (Rel. 15/16/17) CSI reporting is based on the channel coherence time, which is not suitable when the channel has significant Doppler components. The Doppler components of the channel can be calculated based on measuring a reference signal (RS) burst, where the RS can be CSI-RS or SRS. When the RS is CSI-RS, the UE measures a CSI-RS burst, and use it to obtain Doppler components of the DL channel, and when RS is SRS, the gNB measures an SRS burst, and use it to obtain Doppler components of the UL channel. The obtained Doppler components can be reported by the UE using a codebook (as part of a CS report). Or, the gNB can use the obtained Doppler components of the UL channel to beamform CSI-RS for CSI reporting by the UE. An illustration of channel measurement with and without Doppler components is shown in FIG. 10. When the channel is measured with the Doppler components (e.g., based on an RS burst), the measured channel can remain close to the actual varying channel. On the other hand, when the channel is measured without the Doppler components (e.g., based on a one-shot RS), the measured channel can be far from the actual varying channel.

As described, measuring an RS burst is needed in order to obtain the Doppler components of the channel. This disclosure provides several example embodiments on mechanisms related to measuring an RS (e.g., CSI-RS or SRS) burst.

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, all the following components and embodiments are applicable for UL transmission when the scheduling unit in time is either one subframe (which can consist of one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include all the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” can also be used.

In terms of UE configuration, a UE can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for all the Mₙ subbands within the CSI reporting band. A CSI parameter is configured with “subband” for the CSI reporting band with Mₙ subbands when one CSI parameter is reported for each of the Mₙ subbands within the CSI reporting band.

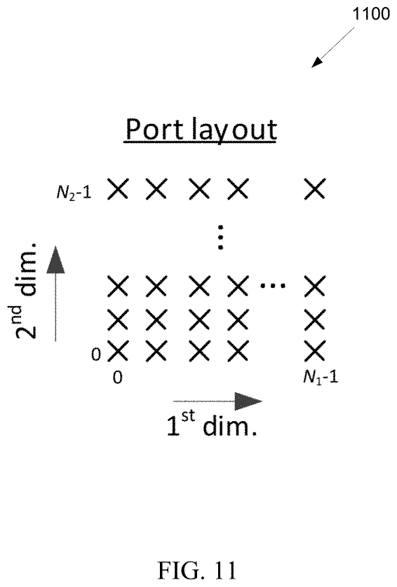

FIG. 11 illustrates an example antenna port layout 1100 according to embodiments of the present disclosure. The embodiment of the antenna port layout 1100 illustrated in FIG. 11 is for illustration only. FIG. 11 does not limit the scope of this disclosure to any particular implementation of the antenna port layout 1100.

As illustrated in FIG. 11, N₁ and N₂ are the number of antenna ports with the same polarization in the first and second dimensions, respectively. For 2D antenna port layouts, N₁>1, N₂>1, and for 1D antenna port layouts N₁>1 and N₂=1. Therefore, for a dual-polarized antenna port layout, the total number of antenna ports is 2N₁N₂.

As described in U.S. Pat. No. 10,659,118, issued May 19, 2020, and entitled “Method and Apparatus for Explicit CSI Reporting in Advanced Wireless Communication Systems,” which is incorporated herein by reference in its entirety, a UE is configured with high-resolution (e.g., Type II) CSI reporting in which the linear combination based Type II CSI reporting framework is extended to include a frequency dimension in addition to the first and second antenna port dimensions.

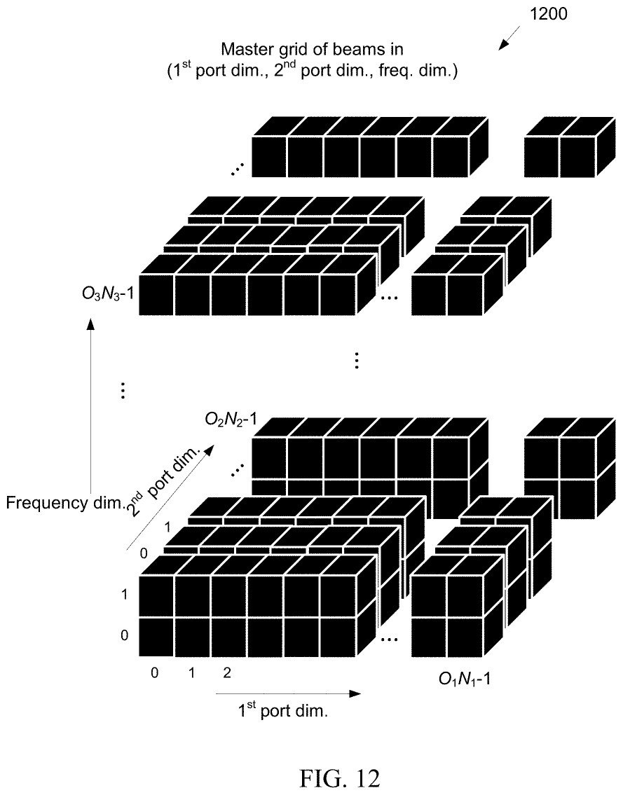

FIG. 12 illustrates a 3D grid 1300 of the oversampled DFT beams (1st port dim., 2nd port dim., freq. dim.) in which
1st dimension is associated with the 1st port dimension,
2nd dimension is associated with the 2nd port dimension, and
3rd dimension is associated with the frequency dimension.
   The basis sets for 1^{st} and 2^{nd} port domain representation are oversampled DFT codebooks of length-N₁ and length-N₂, respectively, and with oversampling factors O₁ and O₂, respectively. Likewise, the basis set for frequency domain representation (i.e., 3rd dimension) is an oversampled DFT codebook of length-N₃ and with oversampling factor O₃. In one example, O₁=O₂=O₃=4. In another example, the oversampling factors Oᵢ belongs to {2, 4, 8}. In yet another example, at least one of O₁, O₂, and O₃ is higher layer configured (via RRC signaling).

As explained in Section 5.2.2.2.6 of REFS, a UE is configured with higher layer parameter codebookType set to ‘ typeII-PortSelection-r16’ for an enhanced Type II CSI reporting in which the pre-coders for all SBs and for a given layer l=1, . . . , v, where v is the associated RI value, is given by either

$$\begin{matrix}{W}^{l} = {AC}_{l} {B}^{H} = [ \begin{matrix}{a}_{0} & {a}_{1} & … & {a}_{L - 1}\end{matrix} ] \\ {[ \begin{matrix}{c}_{l , 0 , 0} & {c}_{l , 0 , 1} & … & {c}_{l , 0 , M - 1} \\ {c}_{l , 1 , 0} & {c}_{l , 1 , 1} & … & {c}_{l , 1 , M - 1} \\ ⋮ & ⋮ & ⋮ & ⋮ \\ {c}_{l , L - 1 , 0} & {c}_{l , L - 1 , 1} & … & {c}_{l , L - 1 , M - 1}\end{matrix} ] [ \begin{matrix}{b}_{0} & {b}_{1} & … & {b}_{M - 1}\end{matrix} ]}^{H} \\ = {\sum }_{f = 0}^{M - 1} {\sum }_{i = 0}^{L - 1} {c}_{l , i , f} ( {a}_{i} {b}_{f}^{H} ) \\ = {\sum }_{i = 0}^{L - 1} {\sum }_{f = 0}^{M - 1} {c}_{l , i , f} ( {a}_{i} {b}_{f}^{H} ) ,\end{matrix} \qquad ( Eq . 1 )$$

$$or$$

$$\begin{matrix}{W}^{l} = [ \begin{matrix}A & 0 \\ 0 & A\end{matrix} ] {C}_{l} {B}^{H} = [ \begin{matrix}\begin{matrix}{a}_{0} & {a}_{1} & … & {a}_{L - 1}\end{matrix} & 0 \\ 0 & \begin{matrix}{a}_{0} & {a}_{1} & … & {a}_{L - 1}\end{matrix}\end{matrix} ] \\ {[ \begin{matrix}{c}_{l , 0 , 0} & {c}_{l , 0 , 1} & … & {c}_{l , 0 , M - 1} \\ {c}_{l , 1 , 0} & {c}_{l , 1 , 1} & … & {c}_{l , 1 , M - 1} \\ ⋮ & ⋮ & ⋮ & ⋮ \\ {c}_{l , L - 1 , 0} & {c}_{l , L - 1 , 1} & … & {c}_{l , L - 1 , M - 1}\end{matrix} ] [ \begin{matrix}{b}_{0} & {b}_{1} & … & {b}_{M - 1}\end{matrix} ]}^{H} \\ = [ \begin{matrix}{\sum }_{f = 0}^{M - 1} {\sum }_{i = 0}^{L - 1} {c}_{l , i , f} ( {a}_{i} {b}_{f}^{H} ) \\ {\sum }_{f = 0}^{M - 1} {\sum }_{i = 0}^{L - 1} {c}_{l , i + L , f} ( {a}_{i} {b}_{f}^{H} )\end{matrix} ] ,\end{matrix} \qquad ( Eq . 2 )$$

where
N₁ is a number of antenna ports in a first antenna port dimension (having the same antenna polarization),
N₂ is a number of antenna ports in a second antenna port dimension (having the same antenna polarization),
P_{CSI-RS} is a number of CSI-RS ports configured to the UE,
N₃ is a number of SBs for PMI reporting or number of FD units or number of FD components (that comprise the CSI reporting band) or a total number of precoding matrices indicated by the PMI (one for each FD unit/component),
aᵢ is a 2N₁N₂×1 (Eq. 1) or N₁N₂×1 (Eq. 2) column vector, and aᵢ is a N₁N₂×1 or

$$\frac{{P}_{CSIRS}}{2} \times 1$$

port selection column vector if antenna ports at the gNB are co-polarized, and is a 2N₁N₂×1 or P_{CSIRS}×1 port selection column vector if antenna ports at the gNB are dual-polarized or cross-polarized, where a port selection vector is a defined as a vector which contains a value of 1 in one element and zeros elsewhere, and P_{CSIRS} is the number of CSI-RS ports configured for CSI reporting,
b_{f} is a N₃×1 column vector,
c_{l,i,f} is a complex coefficient associate with vectors aᵢ and b_{f}.

In a variation, when the UE reports a subset K<2LM coefficients (where K is either fixed, configured by the gNB or reported by the UE), then the coefficient c_{l,i,f} in precoder equations Eq. 1 or Eq. 2 is replaced with x_{l,i,f}×c_{l,i,f}, where
x_{l,i,f}=1 if the coefficient c_{l,i,f} is reported by the UE according to some embodiments of this disclosure.
x_{l,i,f}=0 otherwise (i.e., c_{l,i,f} is not reported by the UE).
   The indication whether x_{l,i,f}=1 or 0 is according to some embodiments of this disclosure. For example, it can be via a bitmap.

In a variation, the precoder equations Eq. 1 or Eq. 2 are respectively generalized to

$${W}^{l} = {\sum }_{i = 0}^{L - 1} {\sum }_{f = 0}^{{M}_{i} - 1} {c}_{l , i , f} ( {a}_{i} {b}_{i , f}^{H} ) \qquad ( Eq . 3 )$$

$$and$$

$${W}^{l} = [ \begin{matrix}{\sum }_{i = 0}^{L - 1} {\sum }_{f = 0}^{{M}_{i} - 1} {c}_{l , i , f} ( {a}_{i} {b}_{i , f}^{H} ) \\ {\sum }_{i = 0}^{L - 1} {\sum }_{= 0}^{{M}_{i} - 1} {c}_{l , i + L , f} ( {a}_{i} {b}_{i , f}^{H} )\end{matrix} ] , \qquad ( Eq . 4 )$$

where for a given i, the number of basis vectors is Mᵢ and the corresponding basis vectors are {b_{i,f}}. Note that Mᵢ is the number of coefficients c_{l,i,f} reported by the UE for a given i, where Mᵢ≤M (where {Mᵢ} or ΣMᵢ is either fixed, configured by the gNB or reported by the UE).

The columns of W^{l} are normalized to norm one. For rank R or R layers (v=R), the pre-coding matrix is given by

$${W}^{( R )} = \frac{1}{\sqrt{R}} [ \begin{matrix}{W}^{1} & {W}^{2} & … & {W}^{R}\end{matrix} ] .$$

Eq. 2 is assumed in the rest of the disclosure. The embodiments of the disclosure, however, are general and are also application to Eq. 1, Eq. 3 and Eq. 4.

Here

$$L \leq \frac{{P}_{CSI - RS}}{2} and M \leq {N}_{3} . If L = \frac{{P}_{CSI - RS}}{2} ,$$

then A is an identity matrix, and hence not reported. Likewise, if M=N₃, then B is an identity matrix, and hence not reported. Assuming M<N₃, in an example, to report columns of B, the oversampled DFT codebook is used. For instance, b_{f}=w_{f}, where the quantity w_{f} is given by

$${w}_{f} = {[ \begin{matrix}1 & {e}^{j \frac{2 π {n}_{3 , l}^{( f )}}{{O}_{3} {N}_{3}}} & {e}^{j \frac{2 π \cdot 2 {n}_{3 , l}^{( f )}}{{O}_{3} {N}_{3}}} & … & {e}^{j \frac{2 π \cdot ( {N}_{3} - 1 ) {n}_{3 , l}^{( f )}}{{O}_{3} {N}_{3}}}\end{matrix} ]}^{T} .$$

When O₃=1, the FD basis vector for layer l∈{1, . . . , v} (where v is the RI or rank value) is given by

$${w}_{f} = {[ \begin{matrix}{y}_{0 , l}^{( f )} & {y}_{1 , l}^{( f )} & … & {y}_{{N}_{3} - 1 , l}^{( f )}\end{matrix} ]}^{T} , \\ where \\ {y}_{t , l}^{( f )} = {e}^{j \frac{2 π t {n}_{3 , l}^{( f )}}{{N}_{3}}} \\ and \\ {n}_{3 , l} = [ {n}_{3 , l}^{( 0 )} , … , {n}_{3 , l}^{( M - 1 )} ] \\ where \\ {n}_{3 , l}^{( f )} ∈ \{ 0 , 1 , … , {N}_{3} - 1 \} .$$

In another example, discrete cosine transform DCT basis is used to construct/report basis B for the 3^{rd} dimension. The m-th column of the DCT compression matrix is simply given by

$${[ {w}_{f} ]}_{n m} = \{ \begin{matrix}\frac{1}{\sqrt{K}} , n = 0 \\ \sqrt{\frac{2}{K}} cos \frac{π ( 2 m + 1 ) n}{2 K} , n = 1 , … K - 1\end{matrix} , \\ and \\ K = {N}_{3} , \\ and \\ m = 0 , … , {N}_{3} - 1 .$$

Since DCT is applied to real valued coefficients, the DCT is applied to the real and imaginary components (of the channel or channel eigenvectors) separately. Alternatively, the DCT is applied to the magnitude and phase components (of the channel or channel eigenvectors) separately. The use of DFT or DCT basis is for illustration purpose only. The disclosure is applicable to any other basis vectors to construct/report A and B.

On a high level, a precoder W^{l} can be described as follows.

W=AₗCₗBₗ^{H}=W₁\tilde{W}₂W_{f}^{H}, (5)

where A=W₁ corresponds to the Rel. 15 Wᵢ in Type II CSI codebook [REFS], and B=W_{f}.

The Cₗ=\tilde{W}₂ matrix consists of all the required linear combination coefficients (e.g., amplitude and phase or real or imaginary). Each reported coefficient (c_{l,i,f}=p_{l,i,f}φ_{l,i,f}) in \tilde{W}₂ is quantized as amplitude coefficient (p_{l,i,f}) and phase coefficient (φ_{l,i,f}). In one example, the amplitude coefficient (p_{l,i,f}) is reported using a A-bit amplitude codebook where A belongs to {2, 3, 4}. If multiple values for A are supported, then one value is configured via higher layer signaling. In another example, the amplitude coefficient (p_{l,i,f}) is reported as p_{l,i,f}=p_{l,i,f}⁽¹⁾p_{l,i,f}⁽²⁾ where
p_{l,i,f}⁽¹⁾ is a reference or first amplitude which is reported using a A1-bit amplitude codebook where A1 belongs to {2, 3, 4}, and
p_{l,i,f}⁽²⁾ is a differential or second amplitude which is reported using a A2-bit amplitude codebook where A2≤A1 belongs to {2, 3, 4}.

For layer l, let us denote the linear combination (LC) coefficient associated with spatial domain (SD) basis vector (or beam) i∈{0, 1, . . . , 2L−1} and frequency domain (FD) basis vector (or beam) f∈{0, 1, . . . , M−1} as c_{l,i,f}, and the strongest coefficient as c_{l,i*,f*}. The strongest coefficient is reported out of the K_{NZ} non-zero (NZ) coefficients that is reported using a bitmap, where K_{NZ}≤K₀=┌β×2LM┐<2LM and β is higher layer configured. The remaining 2LM−K_{NZ} coefficients that are not reported by the UE are assumed to be zero. The following quantization scheme is used to quantize/report the K_{NZ} NZ coefficients.

The UE reports the following for the quantization of the NZ coefficients in \tilde{W}₂
A X-bit indicator for the strongest coefficient index (i*, f*), where X=┌log₂ K_{NZ}┐ or ┌log₂ 2L┐.
   Strongest coefficient c_{l,i*,f*}=1 (hence its amplitude/phase are not reported)
Two antenna polarization-specific reference amplitudes is used.
   For the polarization associated with the strongest coefficient c_{l,i*,f*}=1, since the reference amplitude p_{l,i,f}⁽¹⁾=1, it is not reported
   For the other polarization, reference amplitude p_{l,i,f}⁽¹⁾ is quantized to 4 bits
      The 4-bit amplitude alphabet is

$$\{ 1 , {( \frac{1}{2} )}^{\frac{1}{4}} , {( \frac{1}{4} )}^{\frac{1}{4}} , {( \frac{1}{8} )}^{\frac{1}{4}} , … , {( \frac{1}{{2}^{14}} )}^{\frac{1}{4}} \} .$$

For {c_{l,i,f}, (i,f)≠(i*, f*)}:
   For each polarization, differential amplitudes p_{l,i,f}⁽²⁾ of the coefficients calculated relative to the associated polarization-specific reference amplitude and quantized to 3 bits
      The 3-bit amplitude alphabet is

$$\{ 1 , \frac{1}{\sqrt{2}} , \frac{1}{2} , \frac{1}{2 \sqrt{2}} , \frac{1}{4} , \frac{1}{4 \sqrt{2}} , \frac{1}{8} , \frac{1}{8 \sqrt{2}} \} .$$

Note: The final quantized amplitude p_{l,i,f} is given by p_{l,i,f}⁽¹⁾×p_{l,i,f}⁽²⁾
Each phase is quantized to either 8PSK (Nₚₕ=8) or 16PSK (Nₚₕ=16) (which is configurable).

For the polarization r*∈{0,1} associated with the strongest coefficient c_{l,i*,f*}, we have

$${r}^{*} = ⌊ \frac{{i}^{*}}{L} ⌋$$

and the reference amplitude p_{l,i,f}⁽¹⁾=p_{l,r*}⁽¹⁾=1. For the other polarization r∈{0,1} and r≠r*, we have

$$r = ( ⌊ \frac{{i}^{*}}{L} ⌋ + 1 )$$

mod 2 and the reference amplitude p_{l,i,f}⁽¹⁾=p_{l,r}⁽¹⁾ is quantized (reported) using the 4-bit amplitude codebook mentioned above.
A UE can be configured to report M FD basis vectors. In one example,

$$M = ⌈ p \times \frac{{N}_{3}}{R} ⌉ ,$$

where R is higher-layer configured from {1,2} and p is higher-layer configured from

$$\{ \frac{1}{4} , \frac{1}{2} \} .$$

In one example, the p value is higher-layer configured for rank 1-2 CSI reporting. For rank>2 (e.g., rank 3-4), the p value (denoted by v₀) can be different. In one example, for rank 1-4, (p, v₀) is jointly configured from {(½,¼),(¼,¼),(¼,⅛)}, i.e.,

$$M = ⌈ p \times \frac{{N}_{3}}{R} ⌉$$

for rank 1-2 and

$$M = ⌈ {v}_{0} \times \frac{{N}_{3}}{R} ⌉$$

for rank 3-4. In one example, N₃=N_{SB}×R where N_{SB} is the number of SBs for CQI reporting. In the rest of the disclosure, M is replaced with Mᵥ to show its dependence on the rank value v, hence p is replaced with pᵥ, v∈{1,2} and v₀ is replaced with pᵥ, v∈{3,4}.

A UE can be configured to report Mᵥ FD basis vectors in one-step from N₃ basis vectors freely (independently) for each layer l∈{0, 1, . . . , v−1} of a rank v CSI reporting. Alternatively, a UE can be configured to report Mᵥ FD basis vectors in two-step as follows.
In step 1, an intermediate set (InS) comprising N₃′<N₃ basis vectors is selected/reported, wherein the InS is common for all layers.
In step 2, for each layer l∈{0, 1, . . . , v−1} of a rank v CSI reporting, M FD basis vectors are selected/reported freely (independently) from N₃′ basis vectors in the InS.

In one example, one-step method is used when N₃≤19 and two-step method is used when N₃>19. In one example, N₃′=┌αW┐ where α>1 is either fixed (to 2 for example) or configurable.

The codebook parameters used in the DFT based frequency domain compression (eq. 5) are (L, pᵥ for v∈{1,2}, pᵥ for v∈{3,4}, β, α, Nₚₕ). In one example, the set of values for these codebook parameters are as follows.
L: the set of values is {2,4} in general, except L∈{2,4,6} for rank 1-2, 32 CSI-RS antenna ports, and R=1.
(pᵥ for v∈{1,2}, pᵥ for v∈{3,4})∈{(½,¼),(¼,¼),(¼,⅛)}.
β∈{¼,½,¾}.
α∈{1.5,2,2.5,3}
Nₚₕ∈{8,16}.

In another example, the set of values for these codebook parameters are as follows: α=2, Nₚₕ=16, and as in Table 1, where the values of L, β and pᵥ are determined by the higher layer parameter paramCombination-r17. In one example, the UE is not expected to be configured with paramCombination-r17 equal to
3, 4, 5, 6, 7, or 8 when P_{CSI-RS}=⁴,
7 or 8 when number of CSI-RS ports P_{CSI-RS}<³²,
7 or 8 when higher layer parameter typeII-RI-Restriction-r17 is configured with rᵢ=1 for any i>1,
7 or 8 when R=2.

The bitmap parameter typeII-RI-Restriction-r17 forms the bit sequence r₃, r₂, r₁, r₀ where r₀ is the LSB and r₃ is the MSB. When rᵢ is zero, i∈{0, 1, . . . , 3}, PMI and RI reporting are not allowed to correspond to any precoder associated with v=i+1 layers. The parameter R is configured with the higher-layer parameter numberOfPMISubbandsPerCQISubband-r17. This parameter controls the total number of precoding matrices N₃ indicated by the PMI as a function of the number of subbands in csi-ReportingBand, the subband size configured by the higher-level parameter subbandSize and of the total number of PRBs in the bandwidth part.

TABLE 1

| paramCom- | | Pν | | |
|---|---|---|---|---|
| bination | | ν | ν | |
| -r17 | L | ϵ{1,2} | ϵ{3,4} | β |
| 1 | 2 | ¼ | ⅛ | ¼ |
| 2 | 2 | ¼ | ⅛ | ½ |
| 3 | 4 | ¼ | ⅛ | ¼ |
| 4 | 4 | ¼ | ⅛ | 12 |
| 5 | 4 | ¼ | ¼ | ¾ |
| 6 | 4 | ¼ | ¼ | 12 |
| 7 | 6 | ¼ | — | 12 |
| 8 | 6 | ¼ | — | ¾ |

The above-mentioned framework (equation 5) represents the precoding-matrices for multiple (N₃) FD units using a linear combination (double sum) over 2L SD beams and Mᵥ FD beams. This framework can also be used to represent the precoding-matrices in time domain (TD) by replacing the FD basis matrix W_{f} with a TD basis matrix Wₜ, wherein the columns of Wₜ comprises Mᵥ TD beams that represent some form of delays or channel tap locations. Hence, a precoder W¹ can be described as follows.

W=AₗCₗBₗ^{H}=W₁\tilde{W}₂Wₜ^{H}, (equation 5A)

In one example, the Mᵥ TD beams (representing delays or channel tap locations) are selected from a set of N₃ TD beams, i.e., N₃ corresponds to the maximum number of TD units, where each TD unit corresponds to a delay or channel tap location. In one example, a TD beam corresponds to a single delay or channel tap location. In another example, a TD beam corresponds to multiple delays or channel tap locations. In another example, a TD beam corresponds to a combination of multiple delays or channel tap locations.

The abovementioned framework for CSI reporting based on space-frequency compression (equation 5) or space-time compression (equation 5A) frameworks can be extended to Doppler domain (e.g., for moderate to high mobility UEs). This disclosure focuses on a reference signal burst that can be used to obtain Doppler component(s) of the channel, which can be used to perform Doppler domain compression.

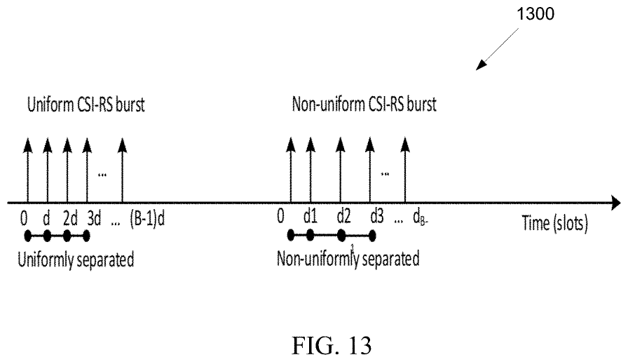

FIG. 13 illustrates an example of a UE configured to receive a burst of non-zero power (NZP) CSI-RS resource(s) 1300 according to embodiments of the present disclosure. The embodiment of the UE configured to receive the burst of NZP CSI-RS resource(s) 1300 illustrated in FIG. 13 is for illustration only. FIG. 13 does not limit the scope of this disclosure to any particular implementation of the UE configured to receive a burst of NZP CSI-RS resource(s) 1300.

In one embodiment, as shown in FIG. 13, a UE is configured to receive a burst of non-zero power (NZP) CSI-RS resource(s), referred to as CSI-RS burst for brevity, in B time slots, where B≥1. The B time slots can be accordingly to at least one of the following examples.
In one example, the B time slots are evenly/uniformly spaced with an inter-slot spacing d.
In one example, the B time slots can be non-uniformly spaced with inter-slot spacing e₁=d₁, e₂=d₂−d₁, e₃=d₃−d₂, . . . , so on, where eᵢ≠eⱼ for at least one pair (i,j) with i≠j.

The UE receives the CSI-RS burst, estimates the B instances of the DL channel measurements, and uses the channel estimates to obtain the Doppler component(s) of the DL channel. The CSI-RS burst can be linked to (or associated with) a single CSI reporting setting (e.g., via higher layer parameter CSI-ReportConfig), wherein the corresponding CSI report includes an information about the Doppler component(s) of the DL channel.

Let hₜ be the DL channel estimate based on the CSI-RS resource(s) received in time slot t∈{0, 1, . . . , B−1}. When the DL channel estimate in slot t is a matrix Gₜ of size N_{Rx}×N_{Tx}×N_{Sc}, then hₜ=vec(Gₜ), where N_{Rx}, N_{Tx}, and N_{Sc} are number of receive (Rx) antennae at the UE, number of CSI-RS ports measured by the UE, and number of subcarriers in frequency band of the CSI-RS burst, respectively. The notation vec(X) is used to denote the vectorization operation wherein the matrix X is transformed into a vector by concatenating the elements of the matrix in an order, for example, 1→2→3→ and so on, implying that the concatenation starts from the first dimension, then moves second dimension, and continues until the last dimension. Let H_{B}=[h₀ h₁ . . . h_{B-1}] be a concatenated DL channel. The Doppler component(s) of the DL channel can be obtained based on H_{B}. For example, H_{B} can be represented as CΦ^{H}=Σ_{S=0}^{N-1}c_{S}ϕ_{S}^{H} where Φ=[ϕ₀ ϕ₁ . . . ϕ_{N-1}] is a Doppler domain (DD) basis matrix whose columns comprise basis vectors, C=[c₀ c₁ . . . c_{N-1}] is a coefficient matrix whose columns comprise coefficient vectors, and N<B is the number of DD basis vectors. Since the columns of H_{B} are likely to be correlated, a DD compression can be achieved when the value of N is small (compared to the value of B). In this example, the Doppler component(s) of the channel is represented by the DD basis matrix Φ and the coefficient matrix C.

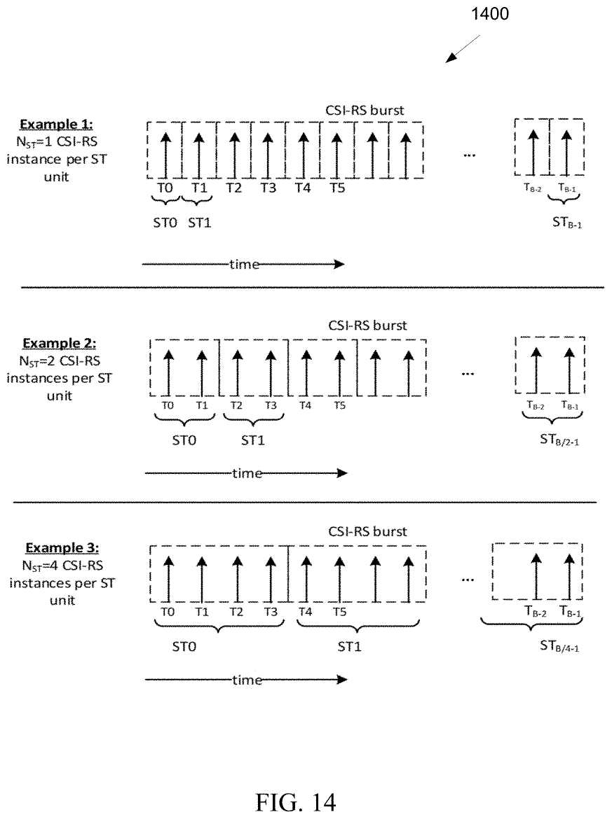

FIG. 14 illustrates an example of a UE configured to determine a value of N₄ based on the value B in a CSI-RS burst 1400 according to embodiments of the present disclosure. The embodiment of the UE configured to determine a value of N₄ based on the value B in a CSI-RS burst 1400 illustrated in FIG. 14 is for illustration only. FIG. 14 does not limit the scope of this disclosure to any particular implementation of the UE configured to determine a value of N₄ based on the value B in a CSI-RS burst 1400.

Let N₄ be the length of the basis vectors {ϕₛ}, e.g., each basis vector is a length N₄×1 column vector.

In one embodiment I.1, a UE is configured to determine a value of N₄ based on the value B (number of CSI-RS instances) in a CSI-RS burst and components across which the DD compression is performed, where each component corresponds to one or multiple time instances within the CSI-RS burst. In one example, N₄ is fixed (e.g., N₄=B) or configured (e.g., via RRC or MAC CE or DCI) or reported by the UE (as part of the CSI report). In one example, the B CSI-RS instances can be partitioned into sub-time (ST) units (instances), where each ST unit is defined as (up to) N_{ST} contiguous time instances in the CSI-RS burst. In this example, a component for the DD compression corresponds to a ST unit. Three examples of the ST units are shown in FIG. 14. In the first example, each ST unit comprises N_{ST}=1 time instance in the CSI-RS burst. In the second example, each ST unit comprises N_{ST}=2 contiguous time instances in the CSI-RS burst. In the third example, each ST unit comprises N_{ST}=4 contiguous time instances in the CSI-RS burst.

The value of N_{ST} can be fixed (e.g., N_{ST}=1 or 2 or 4) or indicated to the UE (e.g., via higher layer RRC or MAC CE or DCI based signaling) or reported by the UE (e.g., as part of the CSI report). The value of N_{ST} (fixed or indicated or reported) can be subject to a UE capability reporting. The value of N_{ST} can also be dependent on the value of B (e.g., one value for a range of values for B and another value for another range of values for B).

At least one of the following examples can be used/configured regarding the ST units.

In one example I.1.1, when N_{ST} divides B, then

$${N}_{4} = \frac{B}{{N}_{S T}} ,$$

and each ST unit comprises N_{ST} continuous time instances, i.e., ST₀ comprises time instances T₀, T₁, . . . , T_{N}_{_{ST}}₋₁, ST₁ comprises time instances T_{N}_{_{ST}}, T_{N}_{_{ST}}₊₁, . . . , T_{2N}_{_{ST}}₋₁, and so on. In general, STₓ comprises time instances T_{xN}_{_{ST}}, T_{xN}_{_{ST}}₊₁, . . . , T_{(x+1)N}_{_{ST}}₋₁. FIG. 14 includes three examples, wherein N_{ST} divides B, for example, when B=16.

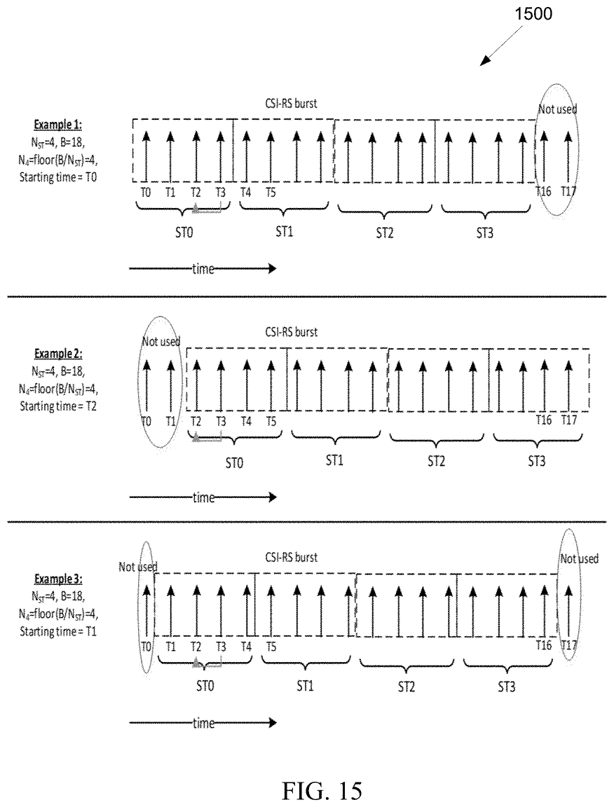

FIG. 15 illustrates an example of a UE configured to determine a value of N₄ when N_{ST} does not divide B 1500 according to embodiments of the present disclosure. The embodiment of the UE configured to determine a value of N₄ when N_{ST} does not divide B 1500 illustrated in FIG. 15 is for illustration only. FIG. 15 does not limit the scope of this disclosure to any particular implementation of the UE configured to determine a value of N₄ when N_{ST} does not divide B 1500.

In one example I.1.2, when N_{ST} does not divide B, then at least one of the following examples can be used/configured.

$${N}_{4} = ⌊ \frac{B}{{N}_{S T}} ⌋ ,$$

In one example I.1.2.1, where IA denotes a flooring function which maps a number y to the largest integer z which satisfies z≤y. The Z=B−(N₄−1)N_{ST} continuous time instances are not used, and the remaining are used to obtain N₄ ST units, each comprising N_{ST} continuous time instances. The Z continuous time instances that are not used can either be in the beginning (i.e., T₀ . . . T_{Z-1}) or in the end (i.e., T_{B-Z} . . . T_{B-1}) or in both (beginning and end). Hence, the starting time instance to obtain N₄ ST units can be any one of T₀ . . . T_{Z-1}. When the starting time instance is T₀, then time instances T₀, T₁, . . . , T_{N}_{₄}_{N}_{_{ST}}₋₁ are used to form ST units, and the remaining time instances T_{N}_{₄}_{N}_{_{ST}} . . . T_{B-1} are not used. Or, when the starting time instance is T_{Z-1}, then time instances T_{Z-1}, T_{Z}, . . . , T_{B-1} are used to form ST units, and the remaining time instances T₀ . . . T_{Z-2} are not used. The starting time instance can be fixed (e.g., T₀) or configured (e.g., via RRC or MAC CE or DCI) or reported by the UE. Three examples are shown in FIG. 15. In example 1, the starting time is T₀, and there are 2 time instances in the end that are not used, and the remaining are used to obtain 4 ST units. In example 2, the starting time is T₂, and there are 2 time instances in the beginning that are not used, and the remaining are used to obtain 4 ST units. In example 3, the starting time is T₁, and there are 2 time instances, one in the beginning and another in the end, that are not used, and the remaining are used to obtain 4 ST units.

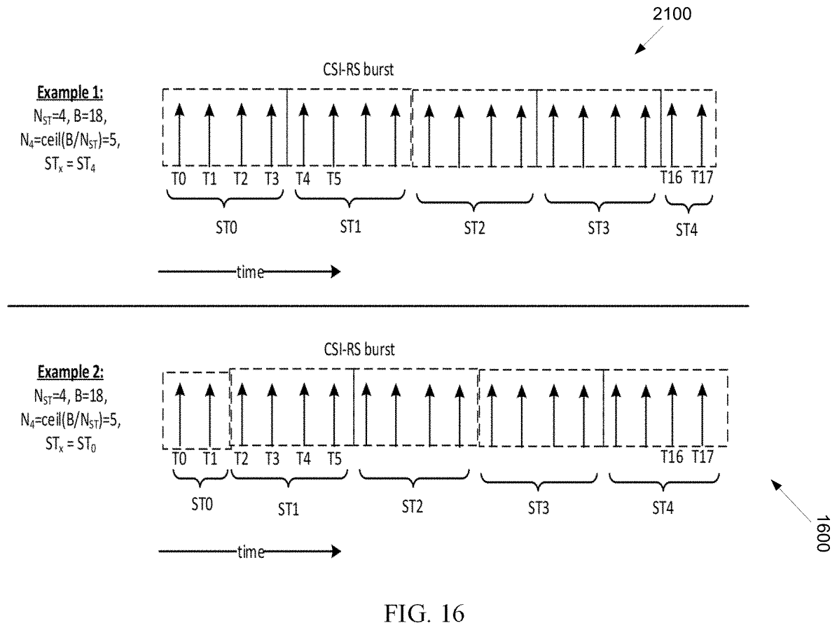

FIG. 16 illustrates an example of a UE configured to determine a value of N₄ when N_{ST} does not divide B 1600 according to embodiments of the present disclosure. The embodiment of the UE configured to determine a value of N₄ when N_{ST} does not divide B 1600 illustrated in FIG. 16 is for illustration only. FIG. 16 does not limit the scope of this disclosure to any particular implementation of the UE configured to determine a value of N₄ when N_{ST} does not divide B 1600.

In one example I.1.2.2,

$${N}_{4} = ⌈ \frac{B}{{N}_{S T}} ⌉ ,$$

where ┌y┐ denotes a ceiling function which maps a number y to the smallest integer z which satisfies y≤z. One of the N₄ ST units, say STₓ, comprises Z=B−(N₄−1)N_{ST} ST continuous time instances (which is less than N_{ST}), and each of the remaining N₄−1 ST units comprises N_{ST} continuous time instances. The STₓ can be one of ST₀ and ST_{N}_{₄}₋₁. The STₓ can be fixed (e.g., T₀) or configured (e.g., via RRC or MAC CE or DCI) or reported by the UE. When STₓ=ST₀, the first ST₀ comprises Z<N_{ST} time instances T₀, T₁, . . . , T_{Z-1}, where Z=B−(N₄−1)N_{ST}; and each of ST₁ . . . ST_{N}_{₄}₋₁ comprises N_{ST} time instances, i.e., ST₁ comprises time instances T_{Z}, T_{Z+1}, . . . , T_{Z+N}_{_{ST}}₋₁, ST₂ comprises time instances T_{Z+N}_{_{ST}}, T_{Z+N}_{_{ST}}₊₁, . . . , T_{Z+2N}_{_{ST}}₋₁, and so on until the last ST_{N}_{₄}₋₁ comprises T_{Z+(N}_{₄}_{-2)N}_{_{ST}}, T_{Z+(N}_{₄}_{-2)N}_{_{ST}}₊₁, . . . , T_{B-1}. Likewise, when ST₀, =ST_{N}_{₄}₋₁, the last ST_{N}_{₄}₋₁ comprises Z<N_{ST} time instances T_{B-Z}, . . . , T_{B-1}; and each of ST₀ . . . ST_{N}_{₄}₋₂ comprises N_{ST} time instances, i.e., ST₀ comprises time instances T₀, T₁, . . . , T_{N}_{_{ST}}₋₁, ST₁ comprises time instances T_{N}_{_{ST}}, T_{N}_{_{ST}}₊₁, . . . , T_{2N}_{_{ST}}₋₁, and so on until the ST_{N}_{₄}₋₂ comprises time instances T_{(N}_{₄}_{-2)N}_{_{ST}}, T_{(N}_{₄}_{-2)N}_{_{ST}}₊₁, . . . , T_{(N}_{₄}_{-2)N}_{_{ST}}₋₁. Two examples are shown in FIG. 16. In example 1, STₓ=ST₄, and there are 2 time instances in the end that form ST₄ having Z<N_{ST} time instances, and the remaining are used to obtain 4 ST units. In example 2, STₓ=ST₀, and there are 2 time instances in the beginning that form ST₀ having Z<N_{ST} time instances, and the remaining are used to obtain 4 ST units.

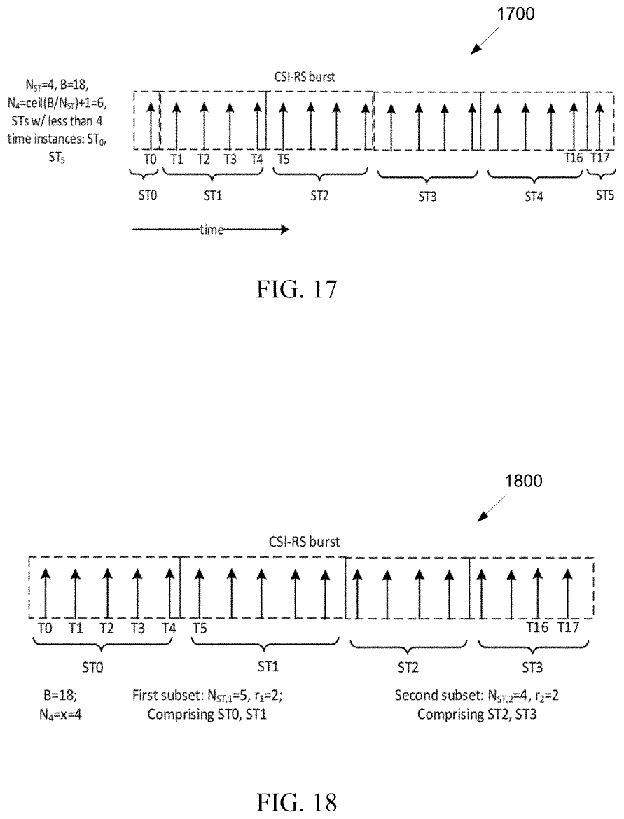

FIG. 17 illustrates an example of a UE configured to determine a value of N₄ when N_{ST} does not divide B 1700 according to embodiments of the present disclosure. The embodiment of the UE configured to determine a value of N₄ when N_{ST} does not divide B 1600 illustrated in FIG. 17 is for illustration only. FIG. 17 does not limit the scope of this disclosure to any particular implementation of the UE configured to determine a value of N₄ when N_{ST} does not divide B 1700.

In one example I.1.2.3,

$${N}_{4} = ⌈ \frac{B}{{N}_{S T}} ⌉ + 1 if 2 \leq Z = B - ( {N}_{4} - 1 ) {N}_{S T} < {N}_{S T} .$$

Two of the N₄ ST units, ST₀ and ST_{N}_{₄}₋₁, comprises at least one but less than N_{ST} continuous time instances, and each of ST₁ . . . ST_{N}_{₄}₋₂ comprises N_{ST} continuous time instances. An example is shown in FIG. 17. The number of time instances comprising ST₀ and ST_{N}_{₄}₋₁ can be according to at least one of the following.

In one example, ST₀ comprises

$$\frac{Z}{2}$$

time instances (in the beginning) and ST_{N}_{₄}₋₁ comprises

$$\frac{Z}{2}$$

time instances (in the end).
In one example, ST₀ comprises

$$⌈ \frac{Z}{2} ⌉$$

time instances (in the beginning) and ST_{N}_{₄}₋₁ comprises

$$⌊ \frac{Z}{2} ⌋ or Z - ⌈ \frac{Z}{2} ⌉$$

time instances (in the end).
In one example, ST₀ comprises

$$⌊ \frac{Z}{2} ⌋$$

time instances (in the beginning) and ST_{N}_{₄}₋₁ comprises

$$⌈ \frac{Z}{2} ⌉ or Z - ⌊ \frac{Z}{2} ⌋$$

time instances (in the end).
When Z=1, at least one example in Example I.1.2.1 or in Example I.1.2.2 can be used.

FIG. 18 illustrates an example of a UE configured to determine a value of N₄ based on the ST unit 1800 according to embodiments of the present disclosure. The embodiment of the UE configured to determine a value of N₄ based on the ST unit 1800 illustrated in FIG. 18 is for illustration only. FIG. 18 does not limit the scope of this disclosure to any particular implementation of the UE configured to determine a value of N₄ based on the ST unit 1800.

In one embodiment I.2, a UE is configured to determine a value of N₄ based on the ST unit (cf. embodiment I.1). In particular, the B CSI-RS instances in the CSI-RS burst can be partitioned into sub-time (ST) units (instances), where each ST unit is defined as contiguous time instances in the CSI-RS burst. At least one of the following examples can be used/configured.

In one example I.2.1, a ST unit comprises all time instances in the CSI-RS burst. So, the value of N₄=1. In this example, the DD compression may not be performed.

In one example I.2.2, the B time instances in the CSI-RS burst is partitioned into r parts, and each part corresponds to a ST unit. So, the value of N₄=r. When r divides B, then each ST unit comprises

$${N}_{S T} = \frac{B}{r}$$

contiguous time instances, i.e., ST₀ comprises time instances T₀, T₁, . . . , T_{N}_{_{ST−1}}, ST₁ comprises time instances T_{N}_{_{ST}}, T_{N}_{_{ST+1}}, . . . , T_{2N}_{_{ST}}₋₁, and so on. When r does not divide B, then a first subset of STs comprises

$${N}_{S T , 1} = ⌈ \frac{B}{r} ⌉$$

contiguous time instances, and a remaining (second subset of) STs comprises

$${N}_{ST , 2} = ⌊ \frac{B}{r} ⌋$$

contiguous time instances. The first subset corresponds to r₁ STs, and the second subset corresponds to r₂=r−r₁ STs. In one example, the first subset corresponds to ST₀, ST₁, . . . STᵣ_{₁}₋₁, and the second subset corresponds to STᵣ_{₁}, STᵣ_{₁}₊₁, . . . STᵣ₋₁. Each ST unit in the first subset comprises

$${N}_{S T , 1} = ⌈ \frac{B}{r} ⌉$$

contiguous time instances, i.e., ST₀ comprises time instances T₀, T₁, . . . , T_{N}_{_{ST,1}}₋₁, ST₁ comprises time instances T_{N}_{_{ST,1}}₁, T_{N}_{_{ST,1}}₊₁, . . . , T_{2N}_{_{ST,1}}₋₁, and so on until STᵣ_{₁}₋₁ comprises time instances T₍ᵣ_{₁}_{-1)N}_{_{ST,1}}, T₍ᵣ_{₁}_{-1)N}_{_{ST,1}}₊₁, . . . , T₍ᵣ_{₁}_{-1)N}_{_{ST,1}}₋₁. Each ST unit in the second subset comprises

$${N}_{ST , 2} = ⌊ \frac{B}{r} ⌋$$

contiguous time instances, i.e., STᵣ_{₁} comprises time instances Tₓ, Tₓ₊₁, . . . , T_{x+N}_{_{ST,2}}₋₁, STᵣ_{₁₊₁} comprises time instances T_{x+N}_{_{ST,2}}, T_{x+N}_{_{ST,2}}₊₁, . . . , T_{x+N}_{_{ST,2}}₋₁, and so on until STᵣ₋₁ comprises time instances Tₓ₊₍ᵣ_{₂}_{-1)N}_{_{ST,2}}, Tₓ₊₍ᵣ_{₂}_{-1)N}_{_{ST,2}}₊₁, . . . , Tₓ₊ᵣ_{₂}_{N}_{_{ST,2}}₋₁, where x=r₁N_{ST,1}. An example is illustrated in FIG. 18. In one example, r₁=B mod r. In one example,

$${r}_{1} = B - r ⌊ \frac{B}{r} ⌋ .$$

In one example,

$${r}_{2} = r ⌈ \frac{B}{r} ⌉ - B .$$

The value r can be fixed (e.g., r=2) or configured (e.g., via RRC or MAC CE or DCI) or reported by the UE (e.g., as part of the CSI report). The value of r (fixed or indicated or reported) can be subject to a UE capability reporting. The value of r can also be dependent on the value of B (e.g., one value for a range of values for B and another value for another range of values for B).

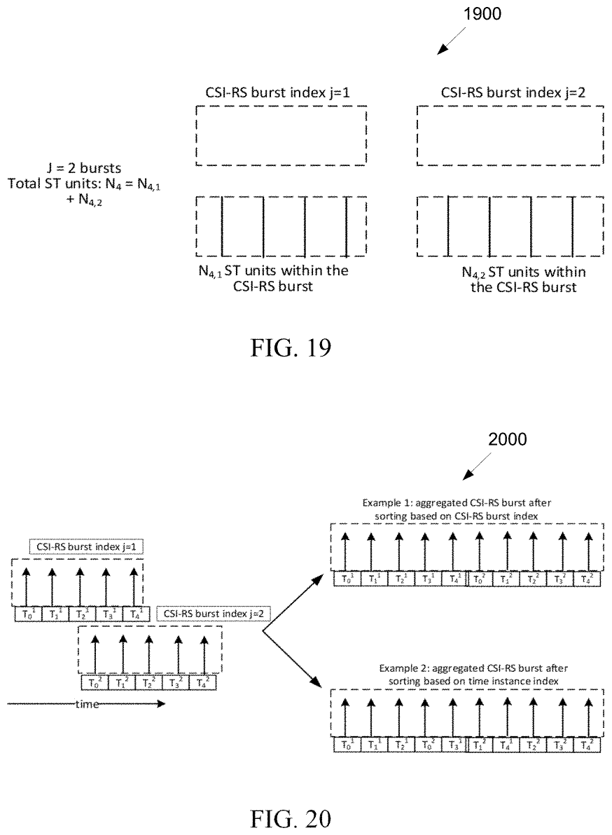

FIG. 19 illustrates an example of a UE configured to determine a value of N₄ based on the value B across J>1 CSI-RS bursts 1900 according to embodiments of the present disclosure. The embodiment of the UE configured to determine a value of N₄ based on the value B across J>1 CSI-RS bursts 1900 illustrated in FIG. 19 is for illustration only. FIG. 19 does not limit the scope of this disclosure to any particular implementation of the UE configured to determine a value of N₄ based on the value B across J>1 CSI-RS bursts 1900.

In one embodiment I.3, a UE is configured to determine a value of N₄ based on the value B (number of CSI-RS instances) across J>1 CSI-RS bursts, and components across which the DD compression is performed, where each component corresponds to one or multiple time instances within the J CSI-RS bursts. Let Bⱼ be the number of CSI-RS instances within the j-th CSI-RS burst, where j∈{1, . . . , J}, and T₀^{j}, T₁^{j}, . . . , T_{B}_{ⱼ}₋₁^{j} indicate the corresponding time instances of the j-th burst. In one example, B=Σⱼ₌₁^{J}Bⱼ. The B CSI-RS instances can be partitioned into sub-time (ST) units (instances), where each ST unit is defined as (up to) N_{ST} contiguous time instances in a CSI-RS burst or across two adjacent CSI-RS bursts. In this example, a component for the DD compression corresponds to a ST unit.

In one example, the ST size N_{ST} is common across J CSI-RS bursts (i.e., one value is used for all CSI-RS bursts). The common value of N_{ST} can be fixed (e.g., N_{ST}=1 or 2 or 4) or indicated to the UE (e.g., via higher layer RRC or MAC CE or DCI based signaling) or reported by the UE (e.g., as part of the CSI report). The common value of N_{ST} (fixed or indicated or reported) can be subject to a UE capability reporting. The value of N_{ST} can also be dependent on the value of B or Bⱼ (e.g., one value for a range of values for B and another value for another range of values for B).

In another example, the ST size N_{ST} is separate (independent) for J CSI-RS bursts (i.e., one separate value is used for each CSI-RS burst). The N_{ST} values for all CSI-RS bursts can be fixed (e.g., 1 or 2 or 4) or indicated to the UE (e.g., via higher layer RRC or MAC CE or DCI based signaling) or reported by the UE (e.g., as part of the CSI report). The values (fixed or indicated or reported) can be subject to a UE capability reporting. The values can also be dependent on the value of or Bⱼ (e.g., one value for a range of values for Bⱼ and another value for another range of values for or Bⱼ). Optionally, a subset of the N_{ST} values for the CSI-RS bursts can be fixed, and the remaining can be indicated to the UE or reported by the UE, where the subset itself can be fixed or configured or reported by the UE.

At least one of the following examples can be used/configured regarding the ST units.

In one example I.3.1, ST units are formed for each CSI-RS burst separately (and not across multiple bursts), and ST units are aggregated across multiple CSI-RS bursts to determine the value of N₄ (total number of ST units across J CSI-RS bursts). An example is illustrated in FIG. 19. For each CSI-RS burst, one of the examples in embodiment I.1 can be used.

In one example I.3.1.1, when the ST size N_{ST} is common across J CSI-RS bursts, then for the j-th CSI-RS burst, the number of ST units N_{4,j} is determined as follows.

When N_{ST} divides Bⱼ, then

$${N}_{4 , j} = \frac{{B}_{j}}{{N}_{S T}} ,$$

and the details of the ST units are as explained in Example I.1.1.
When N_{ST} does not divide Bⱼ, at least one of the following is used.

$${N}_{4 , j} = ⌊ \frac{{B}_{j}}{{N}_{S T}} ⌋$$

and the details of the ST units are as explained in Example I.1.2.1.

$${N}_{4 , j} = ⌈ \frac{{B}_{j}}{{N}_{ST}} ⌉$$

and the details of the ST units are as explained in Example I.1.2.2.

$${N}_{4 , j} = ⌈ \frac{{B}_{j}}{{N}_{ST}} ⌉ + 1$$

and the details of the ST units are as explained in Example I.1.2.3.
In this example, N₄=Σⱼ₌₁^{J}N_{4,j}. Note that when N_{ST} divides all Bⱼ values, then

$${N}_{4} = \frac{{Σ}_{j = 1}^{J} {B}_{j}}{{N}_{ST}} = \frac{B}{{N}_{ST}} .$$

In one example I.3.1.2, when the ST size N_{ST} is separate (independent) for each of the J CSI-RS bursts, denoting the ST size for the j-th burst as N_{ST}^{j}, for the j-th CSI-RS burst, the number of ST units N_{4,j} is determined as follows.
When N_{ST}^{j} divides Bⱼ, then

$${N}_{4 , j} = \frac{{B}_{j}}{{N}_{ST}^{j}} ,$$

and the details of the ST units are as explained in Example I.1.1.
When N_{ST}^{j} does not divide Bⱼ, at least one of the following is used.

$${N}_{4 , j} = ⌊ \frac{{B}_{j}}{{N}_{ST}^{j}} ⌋$$

and the details of the ST units are as explained in Example I.1.2.1.

$${N}_{4 , j} = ⌈ \frac{{B}_{j}}{{N}_{ST}^{j}} ⌉$$

and the details of the ST units are as explained in Example I.1.2.2.

$${N}_{4 , j} = ⌈ \frac{{B}_{j}}{{N}_{ST}^{j}} ⌉ + 1$$

and the details of the ST units are as explained in Example I.1.2.3.
In this example, N₄=Σⱼ₌₁^{J} N_{4,j}. Note that when N_{ST}^{j} divides all Bⱼ values, then

$${N}_{4} = {Σ}_{j = 1}^{J} \frac{{B}_{j}}{{N}_{ST}^{j}} .$$

FIG. 20 illustrates an example of a UE configured to determine a value of N₄ based on the value B across an aggregated CSI-RS burst 2000 according to embodiments of the present disclosure. The embodiment of the UE configured to determine a value of N₄ based on the value B across an aggregated CSI-RS burst 2000 illustrated in FIG. 20 is for illustration only. FIG. 20 does not limit the scope of this disclosure to any particular implementation of the UE configured to determine a value of N₄ based on the value B across an aggregated CSI-RS burst 2000.

In one example I.3.2, ST units can be formed across multiple CSI-RS bursts. For example, the B time instances in J CSI-RS bursts can be ordered (sorted) to form an aggregated CSI-RS burst, and one of the examples in embodiment I.1 can be used to determine N₄ value and corresponding ST units using the (sorted) time instances in the aggregated CSI-RS burst.

In one example, the sorting (ordering) is based on the CSI-RS burst index j. For example, a time instance Tₖ_{₁}^{j}^{₁} precedes (i.e., is assigned a lower index in the aggregated CSI-RS burst) another time instance Tₖ_{₂}^{j}^{₂} if j₁≤j₂, where j₁ and j₂ belong to {1, . . . , J} and are two CSI-RS burst indices. When j₁=j₂ (the same burst index), then Tₖ_{₁}^{j}^{₁} precedes Tₖ_{₂}^{j}^{₂} if k₁<k₂; Tₖ_{₂}^{j}^{₂} precedes Tₖ_{₁}^{j}^{₁}, otherwise.

In one example, the sorting (ordering) is based on time instances. For example, a time instance T₁ precedes another time instance T₂ if T₁≤T₂. When T₁=T₂, the time instance with a smaller CSI-RS burst index precedes. FIG. 20 illustrates the two sorting examples and the corresponding aggregated CSI-RS burst.

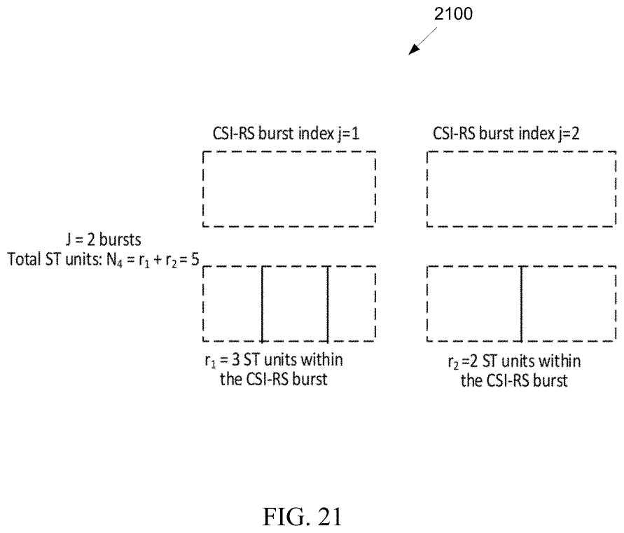

FIG. 21 illustrates an example of a UE configured to determine a value of N₄ based on the ST units formed across. J CSI-RS bursts 2100 according to embodiments of the present disclosure. The embodiment of the UE configured to determine a value of N₄ based on the ST units formed across J CSI-RS bursts 2100 illustrated in FIG. 21 is for illustration only. FIG. 21 does not limit the scope of this disclosure to any particular implementation of the UE configured to determine a value of N₄ based on the ST units formed across J CSI-RS bursts 2100.

In one embodiment I.4, a UE is configured to determine a value of N₄ based on the ST units formed across J CSI-RS bursts (cf. embodiment I.3). In particular, the total of B CSI-RS instances across J CSI-RS bursts can be partitioned into sub-time (ST) units (instances), where each ST unit is defined as contiguous time instances in a CSI-RS burst or across two adjacent CSI-RS bursts. At least one of the following examples can be used/configured.

In one example I.4.1, for each CSI-RS burst, a ST unit comprises all time instances in the CSI-RS burst. So, the value of N₄=J. In this example, the DD compression may be performed across ST units, each of which comprises a CSI-RS burst.

In one example I.4.2, ST units are formed for each CSI-RS burst separately (and not across multiple bursts), and ST units are aggregated across multiple CSI-RS bursts to determine the value of N₄ (total number of ST units across J CSI-RS bursts). For each CSI-RS burst, example 1.2.2 can be used to obtain the ST units. In particular, for each j, the Bⱼ time instances in the j-th CSI-RS burst is partitioned into r parts, and each part corresponds to a ST unit. So, the value of N₄=J×r. Let ST₀^{j}, ST₁^{j}, . . . denotes the ST units corresponding to the j-the CSI-RS burst.

For the j-th CSI-RS burst, when r divides Bⱼ, then each ST unit comprises

$${N}_{ST}^{j} = \frac{{B}_{j}}{r}$$

contiguous time instances, i.e., ST₀^{j} comprises time instances T₀^{j}, T₁^{j}, . . . , T_{N}_{_{ST}}_{^{j}}₋₁^{j}, ST₁^{j} comprises time instances T_{N}_{_{ST}}_{^{j}}^{j}, T_{N}_{_{ST}}_{^{j}}₊₁^{j}, . . . , T_{2N}_{_{ST}}_{^{j}}₊₁^{j}, and so on. When r does not divide Bⱼ, then a first subset of STs comprises

$${N}_{ST , 1}^{j} = ⌈ \frac{{B}_{j}}{r} ⌉$$

contiguous time instances, and a remaining (second subset of) STs comprises

$${N}_{ST , 2}^{j} = ⌊ \frac{{B}_{j}}{r} ⌋$$

contiguous time instances. The first subset corresponds to r₁^{j} STs, and the second subset corresponds to r₂^{j}=r−r₁^{j} STs. In one example, the first subset corresponds to ST₀^{j}, ST₁^{j}, . . . , STᵣ_{₁}_{^{j}}₋₁^{j}, and the second subset corresponds to STᵣ_{₁}_{^{j}}^{j}, STᵣ_{₁}_{^{j}}₊₁^{j}, . . . STᵣ₋₁^{j}. Each ST unit in the first subset comprises

$${N}_{ST , 1}^{j} = ⌈ \frac{{B}_{j}}{r} ⌉$$

contiguous time instances, i.e., ST₀^{j} comprises time instances T₀^{j}, Tⱼ¹, . . . , T_{N}_{_{ST,1}}_{^{j}}₋₁^{j}, ST₁^{j} comprises time instances T_{N}_{_{ST,1}}_{^{j}}^{j}, T_{N}_{_{ST,1}}_{^{j}}₊₁^{j}, . . . , T_{2N}_{_{ST,1}}_{^{j}}₋^{j}, and so on until STᵣ_{₁}_{^{j}}₋₁^{j} comprises time instances T₍ᵣ_{₁}_{^{j}}_{-1)N}_{_{ST,1}}ⱼ, T₍ᵣ_{₁}_{^{j}}_{-1)N}_{_{ST,1}}_{^{j}}₊₁. Each ST unit in the second subset comprises

$${N}_{ST , 2}^{j} = ⌊ \frac{{B}_{j}}{r} ⌋$$

contiguous time instances, i.e., STᵣ_{₁}_{^{j}}^{j} comprises time instances Tₓ^{j}, Tₓ₊₁^{j}, . . . , T_{x+N}_{_{ST,2}}_{^{j}}₋₁^{j}, STᵣ_{₁}_{^{j}}₊₁^{j} comprises time instances T_{x+N}_{_{ST,2}}_{^{j}}^{j}, T_{x+N}_{_{ST,2}}_{^{j}}₊₁^{j}, . . . , T_{x+2N}_{_{ST,2}}_{^{j}}₋₁, and so on until STᵣ₋₁^{j} comprises time instances Tₓ₊₍ᵣ_{₂}_{^{j}}_{-1)N}_{_{ST,2}}ⱼ^{j}, Tₓ₊₍ᵣ_{₂}_{^{j}}_{-1)N}_{_{ST,2}}_{^{j}}₊₁^{j}, . . . , Tₓ₊ᵣ_{₂}_{^{j}}_{N}_{_{ST,2}}_{^{j}}₋₁, where x=r₁^{j}N_{ST,1}^{j}. In one example, r₁^{j}=Bⱼ mod r. In one example,

$${r}_{1}^{j} = {B}_{j} - r ⌊ \frac{{B}_{j}}{r} ⌋ .$$

In one example,

$${r}_{2}^{j} = r ⌈ \frac{{B}_{j}}{r} ⌉ - {B}_{j} .$$

The value r can be fixed (e.g., r=2) or configured (e.g., via RRC or MAC CE or DCI) or reported by the UE (e.g., as part of the CSI report). The value of r (fixed or indicated or reported) can be subject to a UE capability reporting. The value of r can also be dependent on the value of B or Bⱼ (e.g., one value for a range of values for B and another value for another range of values for B).

In one example I.4.3, which is an extension of example I.4.2, the Bⱼ time instances in the j-th CSI-RS burst is partitioned into rⱼ parts, and each part corresponds to a ST unit. So, the value of N₄=Σⱼ₌ᵢ^{J}rⱼ. The rest of the details are the same as in Example I.4.2 except that r is replaced with rⱼ. An example is illustrated in FIG. 21.

The rⱼ values for all CSI-RS bursts can be fixed (e.g., 1 or 2 or 4) or configured (e.g., via RRC or MAC CE or DCI) or reported by the UE (e.g., as part of the CSI report). The values (fixed or indicated or reported) can be subject to a UE capability reporting. The values can also be dependent on the value of Bⱼ (e.g., one value for a range of values for Bⱼ and another value for another range of values for Bⱼ). Optionally, a subset of the rⱼ values for the CSI-RS bursts can be fixed, and the remaining can be indicated to the UE or reported by the UE, where the subset itself can be fixed or configured or reported by the UE.

In one example I.4.4, ST units can be formed across multiple CSI-RS bursts. For example, the B time instances in J CSI-RS bursts can be ordered (sorted) to form an aggregated CSI-RS burst, and example I.2.2 can be used to determine N₄ value and corresponding ST units using the (sorted) time instances in the aggregated CSI-RS burst. The sorting can be according to one of the examples in Example I.3.2.

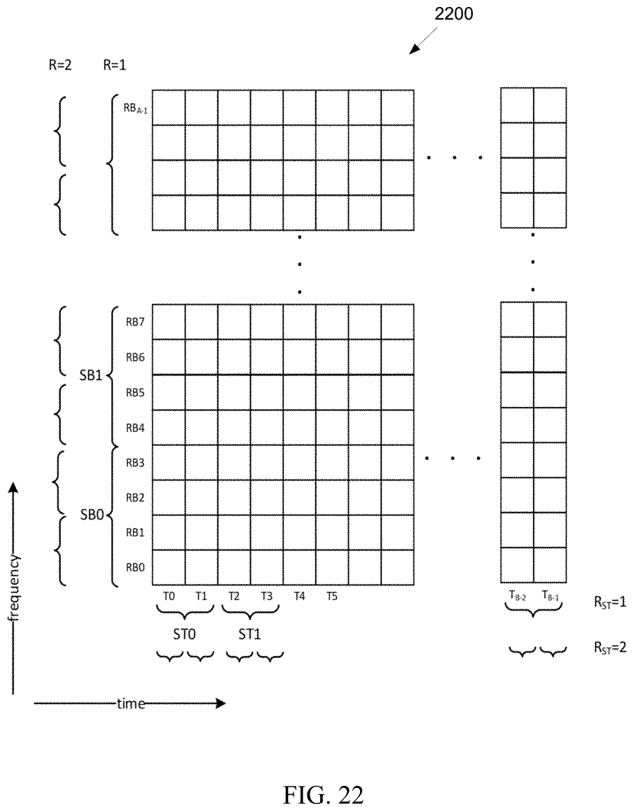

FIG. 22 illustrates an example of a UE configured to determine a value of N₄ with J≥1 CSI-RS bursts that occupy a frequency band and a time span 2200 according to embodiments of the present disclosure. The embodiment of the UE configured to determine a value of N₄ with J≥1 CSI-RS bursts that occupy a frequency band and a time span 2200 illustrated in FIG. 22 is for illustration only. FIG. 22 does not limit the scope of this disclosure to any particular implementation of the UE configured to determine a value of N₄ with J≥1 CSI-RS bursts that occupy a frequency band and a time span 2200.

In one embodiment II.1, a UE is configured with J≥1 CSI-RS bursts (as illustrated earlier in the disclosure) that occupy a frequency band and a time span (duration), wherein the frequency band comprises A RBs, and the time span comprises B time instances (of CSI-RS resource(s)). When J>1, the A RBs and/or B time instances can be aggregated across J CSI-RS bursts. In one example, the frequency band equals the CSI reporting band and the time span equals the number of CSI-RS resource instances (across J CSI-RS bursts), both can be configured to the UE for a CSI reporting, which can be based on the DD compression. The UE is further configured to partition (divide) the A RBs into subbands (SBs) and/or the B time instances into sub-times (STs). The partition of A RBs can be based on a SB size value N_{SB}, which can be configured to the UE (cf. Table 5.2.1.4-2 of REFS). The partition of B time instances can be based either a ST size value N_{ST} or an r value, as described in this disclosure (cf. embodiment I.1 through 1.4). An example is illustrated in FIG. 22, where RB0, RB1, . . . , RB_{A-1} comprise A RBs, T₀, T₁, . . . , T_{B-1} comprise B time instances, the SB size N_{SB}=4, and the ST size N_{ST}=2.

In one example II.1.1, the partitioning of A RBs into SBs is performed when the frequency granularity of CQI and/or PMI reporting is configured (e.g., by higher layer) to be ‘per SB.’ That is, one CQI and/or precoding matrix is/are reported for each SB. For PMI reporting, each SB can be partitioned further into (up to) R parts, similar to the PMI reporting based on the Rel. 16 enhanced Type II codebook. The value of R can belong to {1,2, N_{SB}}. The value of R can be configured (e.g., via higher layer), which can be subject to the UE capability reporting. In one example, the support for R=1 is mandatory (hence, doesn't require additional signaling from the UE), and the support of R>1 is optional (hence, requires additional signaling if the UE supports it). Examples of two R values, R=1,2 are illustrated in FIG. 13, where when R=1, SBs are not partitioned (i.e., 4 RBs form a SB), and when R=2, each SB is partitioned into two parts (i.e., 4 RBs form a SB, which is partitioned into 2 parts, each with 2 RBs). When R>1, a total of N₃ precoding matrices are reported (via the PMI), one for each FD unit/component, where N₃=R×N_{SB}^{tot} when each SB is partitioned into R parts, and N₃=R×(N_{SB}^{tot}−2)+P+Q in general, where N_{SB}^{tot} is the total number of SBs, P is number of parts of the first SB, Q is number of parts of the last SB, and P, Q∈{1, . . . R}.

In one example II.1.2, the partitioning of B time instances into STs is performed when the time granularity of CQI and/or PMI reporting is configured (e.g., by higher layer) to be ‘per ST.’ That is, one CQI and/or precoding matrix is/are reported for each ST. For PMI reporting, each ST can be partitioned further into (up to) R_{ST} parts, similar to the PMI reporting based on the Rel. 16 enhanced Type II codebook. The value of R_{ST} can belong to {1,2, N_{ST}}. The value of R_{ST} can be configured (e.g., via higher layer), which can be subject to the UE capability reporting. In one example, the support for R_{ST}=1 is mandatory (hence, doesn't require additional signaling from the UE), and the support of R_{ST}>1 is optional (hence, requires additional signaling if the UE supports it). Examples of two R_{ST} values, R_{ST}=1,2 are illustrated in FIG. 13, where when R_{ST}=1, STs are not partitioned (i.e., 2 time instances form a ST), and when R_{ST}=2, each ST is partitioned into two parts (2 time instances form a ST, which is partitioned into 2 parts, each with 1 time instance). When R_{ST}>1, a total of N₄ precoding matrices are reported (via the PMI), one for each ST unit/component, where N₄=R_{ST}×N_{ST}^{tot} when each ST is partitioned into R_{ST} parts, and N₄=R_{ST}×(N_{ST}^{tot}−2)+P_{ST}+Q_{ST} in general, where N_{ST}^{tot} is the total number of STs, P_{ST} is number of parts of the first ST, Q_{ST} is number of parts of the last ST, and P_{ST}, Q_{ST}∈{1, . . . R_{ST}}.

In one example II.1.3, the A RBs are partitioned, but the B time instances are not partitioned. In one example, this can be configured to the UE when the frequency granularity of CQI reporting is configured (e.g., by higher layer) to be ‘per SB’ and the time granularity of CQI reporting is configured (e.g., by higher layer) to be ‘wide-time’ or ‘common’ or ‘single’. A total of N_{SB}^{tot} CQI values are reported. The details of the partitioning of A RBs are according to Example II.1.1, one for each ST.

In one example II.1.4, the B time instances are partitioned, but the A RBs are not partitioned. In one example, this can be configured to the UE when the frequency granularity of CQI reporting is configured (e.g., by higher layer) to be ‘per ST’ and the time granularity of CQI reporting is configured (e.g., by higher layer) to be ‘wideband’. A total of N_{ST}^{tot} CQI values are reported. The details of the partitioning of B time instances are according to Example II.1.2, one for each SB.

In one example II.1.5, both A RBs and B time instances are partitioned. In one example, this can be configured to the UE when the frequency granularity of CQI and/or PMI reporting is configured (e.g., by higher layer) to be ‘per SB’ and the time granularity of CQI and/or PMI reporting is configured (e.g., by higher layer) to be ‘per ST’. The details of the partitioning of A RBs are according to Example II.1.1. The details of the partitioning of B time instances are according to Example II.1.2. A total of N^{tot}=N_{SB}^{tot}×N_{ST}^{tot} CQI values and/or precoding matrices are reported, one for each (SD,ST) pair.

In the above examples, the PMI can indicate a precoding matrix for each SB and/or each ST where the precoding matrices for all SBs and/or all STs are determined (calculated) based on a combination of frequency domain (FD) compression and/or DD compression, where the DD compression is performed as described in this disclosure, and the FD compression is performed similar to that in Rel. 16 enhanced Type II codebook. The parameters A, N_{SB}, and R determine a value for N₃, the length of each of the M FD basis vectors that are used/selected to perform the FD compression (cf. Rel. 16 enhanced Type II codebook). Likewise, the parameters B, N_{ST}, and R_{ST} determine a value for N₄, the length of each of the N DD basis vectors that are used/selected to perform the DD compression.

In one example II.1.6, The configuration of parameters for SBs (e.g., N_{SB}, R) and STs (e.g., N_{ST}, R_{ST}) can be separate (e.g., via separate parameters), or joint (e.g., via a joint parameter). For example, the SB size N_{SB} and the ST size N_{ST} can be configured separately (e.g., via separate higher layer parameters). Or, they can be configured jointly (e.g., via a joint higher layer parameter). When configured jointly, a pair of (N_{SB}, N_{ST}) value is configured, where N_{SB} can take value from a set S_{SB} (e.g., {4,8}) and N_{ST} can take a value from a set S_{ST} (e.g., {2,4}), or (N_{SB}, N_{ST}) takes a value from a set of pairs S (e.g., {(2,2),(2,4),(4,2)}). In one example, when (N_{SB}, N_{ST}) takes a value from a set of pairs S, the set comprises pairs (a, b) which satisfy a condition. In one example, the condition corresponds to a×b=c, where c is fixed. For example, when c=4, the set S={(4,1), (2,2), (1,4)}.

Any of the above variation embodiments can be utilized independently or in combination with at least one other variation embodiment.

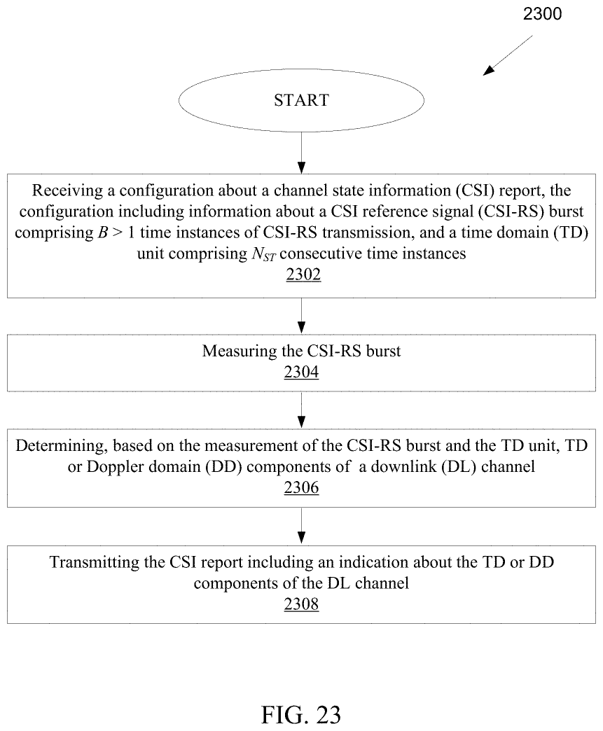

FIG. 23 illustrates a flow chart of a method 2300 for operating a UE, as may be performed by a UE such as UE 116, according to embodiments of the present disclosure. The embodiment of the method 2300 illustrated in FIG. 23 is for illustration only. FIG. 23 does not limit the scope of this disclosure to any particular implementation.

As illustrated in FIG. 23, the method 2300 begins at step 2302. In step 2302, the UE (e.g., 111-116 as illustrated in FIG. 1) receives a configuration about a channel state information (CSI) report, the configuration including information about a CSI reference signal (CSI-RS) burst comprising B>1 time instances of CSI-RS transmission, and a time domain (TD) unit comprising N_{ST} consecutive time instances.

In step 2304, the UE measures the CSI-RS burst.

In step 2306, the UE determines, based on the measurement of the CSI-RS burst and the TD unit, TD or Doppler domain (DD) components of a downlink (DL) channel.

In step 2308, the UE transmits the CSI report including an indication about the TD or DD components of the DL channel.

In one embodiment, a value of N_{ST} is determined based on a higher layer radio resource control (RRC) parameter.

In one embodiment, a number of TD units (N₄) is determined based on B and N_{ST}.

In one embodiment, the TD or DD components include multiple basis vectors, where each basis vector is R_{ST}N₄×1, where R_{ST}≥1, where R_{ST} is a number of precoding matrices within each TD unit.

In one embodiment, R_{ST} is configured via a higher layer parameter.

In one embodiment, the configuration includes information about a TD reporting granularity of a quantity, the CSI report includes the quantity, and the quantity is based on the TD or DD components of the DL channel.

In one embodiment, the quantity is a precoding matrix indicator (PMI) or a channel quality indicator (CQI), and the TD reporting granularity is configured jointly with a frequency domain granularity of the CQI or the PMI via a higher layer parameter.

In one embodiment, the TD reporting granularity is either wide-time (WT) or sub-time (ST), where WT corresponds to the quantity being reported for all of B time instances, and ST corresponds to the quantity being reported for each TD unit within B time instances.

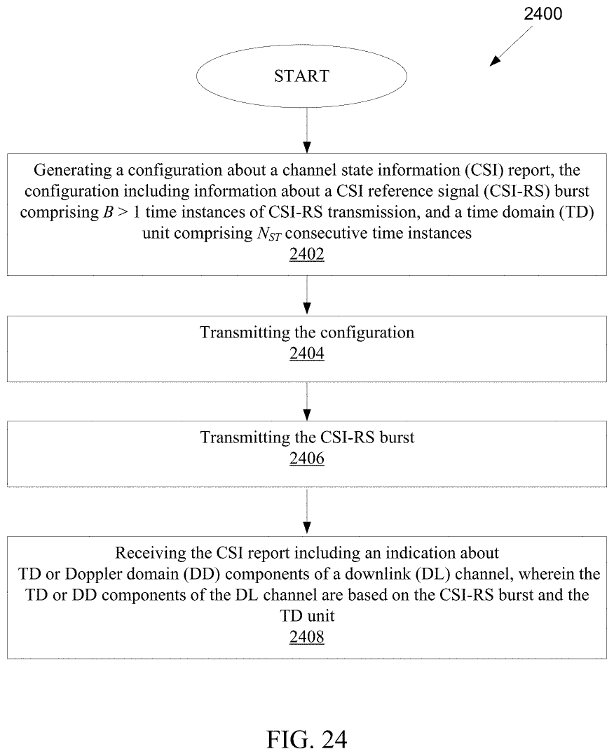

FIG. 24 illustrates a flow chart of another method 2400, as may be performed by a base station (BS) such as BS 102, according to embodiments of the present disclosure. The embodiment of the method 2400 illustrated in FIG. 24 is for illustration only. FIG. 24 does not limit the scope of this disclosure to any particular implementation.

As illustrated in FIG. 24, the method 2400 begins at step 2402. In step 2402, the BS (e.g., 101-103 as illustrated in FIG. 1), generates a configuration about a channel state information (CSI) report, the configuration including information about a CSI reference signal (CSI-RS) burst comprising B>1 time instances of CSI-RS transmission, and a time domain (TD) unit comprising N_{ST} consecutive time instances.

In step 2404, the BS transmits the configuration.

In step 2406, the BS transmits the CSI-RS burst.

In step 2408, the BS receives the CSI report including an indication about TD or Doppler domain (DD) components of a downlink (DL) channel, wherein the TD or DD components of the DL channel are based on the CSI-RS burst and the TD unit.

In one embodiment, a value of N_{ST} is based on a higher layer radio resource control (RRC) parameter.

In one embodiment, a number of TD units (N₄) is determined based on B and N_{ST}.

In one embodiment, the TD or DD components include multiple basis vectors, where each basis vector is R_{ST}N₄×1, where R_{ST}≥1, where R_{ST} is a number of precoding matrices within each TD unit.

In one embodiment, R_{ST} is configured via a higher layer parameter.

In one embodiment, the configuration includes information about a TD reporting granularity of a quantity, the CSI report includes the quantity, and the quantity is based on the TD or DD components of the DL channel.

In one embodiment, the quantity is a precoding matrix indicator (PMI) or a channel quality indicator (CQI), and the TD reporting granularity is configured jointly with a frequency domain granularity of the CQI or the PMI via a higher layer parameter.

In one embodiment, the TD reporting granularity is either wide-time (WT) or sub-time (ST), where WT corresponds to the quantity being reported for all of B time instances, and ST corresponds to the quantity being reported for each TD unit within B time instances.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), the UE comprising:
a transceiver configured to:
receive a configuration about a channel state information (CSI) report, the configuration including information about
a CSI reference signal (CSI-RS) burst comprising B>1 time instances of CSI-RS transmission, and
a time domain (TD) unit comprising N_{ST} consecutive time instances; and
a processor operably coupled to the transceiver, the processor configured to:
measure the CSI-RS burst; and
determine, based on the measurement of the CSI-RS burst and the TD unit, TD or Doppler domain (DD) components of a downlink (DL) channel,
wherein the transceiver is configured to transmit the CSI report including an indication about the TD or DD components of the DL channel.

2. The UE of claim 1, wherein a value of N_{ST} is determined based on a higher layer radio resource control (RRC) parameter.

3. The UE of claim 1, wherein the processor is further configured to determine a number of TD units (N₄) based on B and N_{ST}.

4. The UE of claim 3, wherein the TD or DD components include multiple basis vectors, where each basis vector is R_{ST}N₄×1, where R_{ST}≥1, where R_{ST} is a number of precoding matrices within each TD unit.

5. The UE of claim 4, wherein R_{ST} is configured via a higher layer parameter.

6. The UE of claim 1, wherein:
the configuration includes information about a TD reporting granularity of a quantity,
the CSI report includes the quantity, and
the quantity is based on the TD or DD components of the DL channel.

7. The UE of claim 6, wherein:
the quantity is a precoding matrix indicator (PMI) or a channel quality indicator (CQI), and
the TD reporting granularity is configured jointly with a frequency domain granularity of the CQI or the PMI via a higher layer parameter.

8. The UE of claim 6, wherein the TD reporting granularity is either wide-time (WT) or sub-time (ST), where WT corresponds to the quantity being reported for all of B time instances, and ST corresponds to the quantity being reported for each TD unit within B time instances.

9. A base station (BS) comprising:
a processor configured to:
generate a configuration about a channel state information (CSI) report, the configuration including information about
a CSI reference signal (CSI-RS) burst comprising B>1 time instances of CSI-RS transmission, and
a time domain (TD) unit comprising N_{ST} consecutive time instances; and
a transceiver operably coupled to the processor, the transceiver configured to:
transmit the configuration;
transmit the CSI-RS burst; and
receive the CSI report including an indication about TD or Doppler domain (DD) components of a downlink (DL) channel,
wherein the TD or DD components of the DL channel are based on the CSI-RS burst and the TD unit.

10. The BS of claim 9, wherein a value of N_{ST} is based on a higher layer radio resource control (RRC) parameter.

11. The BS of claim 9, wherein a number of TD units (N₄) is based on B and N_{ST}.

12. The BS of claim 11, wherein the TD or DD components include multiple basis vectors, where each basis vector is R_{ST}N₄×1, where R_{ST}≥1, where R_{ST} is a number of precoding matrices within each TD unit.

13. The BS of claim 12, wherein R_{ST} is configured via a higher layer parameter.

14. The BS of claim 9, wherein:
the configuration includes information about a TD reporting granularity of a quantity,
the CSI report includes the quantity, and
the quantity is based on the TD or DD components of the DL channel.

15. The BS of claim 14, wherein:
the quantity is a precoding matrix indicator (PMI) or a channel quality indicator (CQI), and
the TD reporting granularity is configured jointly with a frequency domain granularity of the CQI or the PMI via a higher layer parameter.

16. The BS of claim 14, wherein the TD reporting granularity is either wide-time (WT) or sub-time (ST), where WT corresponds to the quantity being reported for all of B time instances, and ST corresponds to the quantity being reported for each TD unit within B time instances.

17. A method for operating a user equipment (UE), the method comprising:
receiving a configuration about a channel state information (CSI) report, the configuration including information about
a CSI reference signal (CSI-RS) burst comprising B>1 time instances of CSI-RS transmission, and
a time domain (TD) unit comprising N_{ST} consecutive time instances;
measuring the CSI-RS burst;
determining, based on the measurement of the CSI-RS burst and the TD unit, TD or Doppler domain (DD) components of a downlink (DL) channel; and
transmitting the CSI report including an indication about the TD or DD components of the DL channel.

18. The method of claim 17, further comprising determining a value of N_{ST} based on a higher layer radio resource control (RRC) parameter.

19. The method of claim 17, further comprising determining a number of TD units (N₄) based on B and N_{ST}.

20. The method of claim 19, wherein the TD or DD components include multiple basis vectors, where each basis vector is R_{ST}N₄×1, where R_{ST}≥1, where R_{ST} is a number of precoding matrices within each TD unit.
